(19) United States
(12) Patent Application Publication
(10) Pub. No.: US 2011/0239542 A1
(43) Pub. Date: Oct. 6, 2011

(54) APPARATUS AND METHOD FOR EFFECTING PLASMA-BASED REACTIONS

(75) Inventors: Zhuomin Liu, Moncton (CA); Thomas K. Whidden, Fredericton (CA); Tobie Boutot, Moncton (CA); Yun Yang, Fredericton (CA)

(73) Assignee: Atlantic Hydrogen Inc., Fredericton (CA)

(21) Appl. No.: 13/122,358

(22) PCT Filed: Oct. 1, 2009
(86) PCT No.: PCT/CA2009/001405

§ 371 Date: Jun. 17, 2011

Related U.S. Application Data
(60) Provisional application No. 61/102,722, filed on Oct. 3, 2008.

(51) Int. Cl. C01B 3/32

(52) U.S. Cl. 48/127.5

(57) ABSTRACT

There is provided a reactor system comprising a plasma generator and a reaction vessel. The plasma generator is configured for effecting a plasma discharge into a reaction zone to produce a plasma plume. The reaction vessel defines the reaction zone. The reaction vessel includes a reactant flow inlet configured for flowing and discharging gaseous reactant flow into the reaction zone, and a stabilizing gaseous flow inlet configured for introducing and effecting vortical flow of a stabilizing gaseous fluid into the reaction vessel. The vortical flow of the stabilizing gaseous fluid effects a spatial disposition of the plasma plume such that at least a fraction of the gaseous reactant flow intersects the plasma plume.

### RELATED APPLICATIONS

This application claims priority to U.S. Patent Application Ser. No. 61/102,722 filed on Oct. 3, 2008.

### FIELD OF THE INVENTION

The present invention relates to effecting reactions in a plasma.

### BACKGROUND OF THE INVENTION

Plasma based reactions for effecting reformation of natural gas are known. However, existing methods operate with less than desirable conversion efficiencies and are plagued with issues of carbon deposition.

### SUMMARY OF INVENTION

In one aspect, there is provided a reactor system comprising, a plasma generator configured for effecting a plasma discharge into a reaction zone to produce a plasma plume, a reaction vessel defining the reaction zone, including: a reactant flow inlet configured for flowing and discharging gaseous reactant flow into the reaction zone; and a stabilizing gaseous flow inlet configured for introducing and effecting vortical flow of a stabilizing gaseous fluid into the reaction vessel; wherein the vortical flow of the stabilizing gaseous fluid effects a spatial disposition of the plasma plume such that at least a fraction of the gaseous reactant flow intersects the plasma plume.

In a further aspect, there is provided a reactor system comprising: a plasma generator configured for effecting a plasma discharge into a reaction zone to produce a plasma plume, a reaction vessel defining the reaction zone, including: a reactant flow inlet configured for flowing a gaseous reactant flow into the reaction zone, wherein the reactant flow inlet includes an axis, and a stabilizing gaseous fluid flow inlet configured for introducing and effecting vortical flow of a stabilizing gaseous fluid into the reaction vessel; wherein the vortical flow of the stabilizing gaseous fluid effects a spatial disposition of the plasma plume such that the axis of the reactant flow inlet intersects the plasma plume.

In further aspect, more is provided a method of operating a plasma reactor, generating a plasma plume, flowing a gaseous reactant flow into a reaction zone, effecting a spatial disposition of the plasma plume with a vortical flow of a stabilizing gaseous fluid such that the gaseous reactant flow intersects the plasma plume.

In another aspect, there is provided a reactor system comprising, a reaction vessel defining a reaction zone and including an internal structural surface fluidly communicating with the reaction zone, wherein the internal structural surface includes a plurality of surface portions, a plasma generator configured for effecting a plasma discharge into a reaction zone, including a current and voltage source, a first electrode structure coupled to the reaction vessel, and including at least one operative surface electrically coupled to the current and voltage source for effecting an electrical discharge, a second electrode structure coupled to the reaction vessel, and including at least one operative surface configured for receiving the electrical discharge, wherein the second electrode structure is spaced apart from the first electrode structure, and the reaction zone is disposed between the first and second electrode structures, such that, when a plasma forming gaseous fluid is disposed within the reaction zone and a sufficient electrical potential difference is applied between a one of the at least one operative surface of the first electrode structure and a respective one of the at least one operative surface of the second electrode structure, an electrical discharge is effected between the one of the at least one operative surface of the first electrode structure and the respective one of the at least one operative surface of the second electrode structure and through the reaction zone, and at least a fraction of the plasma forming gaseous fluid is converted into the plasma discharge, wherein each one of the at least one operative surface of the first electrode structure is spaced apart from each one of the at least one operative surface of the second electrode structure by a respective linear distance which is a respective electrode spacing distance, and wherein the respective other electrode spacing distance by which a one of the at least one operative surface is spaced apart from at least one of the at least one operative surface is a minimum electrode spacing distance, and each one of the other ones of the at least one operative surface is spaced apart from each one of the at least one operative surface by a respective other linear distance which is a respective other electrode spacing distance, and wherein the respective other electrode spacing distance is greater than or equal to the minimum electrode spacing distance, and wherein the respective other electrode spacing distance by which at least one of the other ones of the at least one operative surface is spaced apart from at least one of the at least one operative surface is a maximum electrode spacing distance, such that each one of those surface portions of the internal structural surface which are spaced apart from each one of the at least one operative surface of the first electrode structure by a respective linear distance which is a respective operative spacing distance which is greater than a critical distance, is at least one of: a) defined by a substantially non-conducting material, or b) disposed relative to an insulator, provided within the reaction vessel, and is thereby defined as an insulated potentially active surface portion, such that the insulator is disposed between the insulated potentially active surface portion and each one of the at least one operative surface of the first electrode structure, wherein the insulator prevents or substantially prevents electric discharge from substantially each one of the at least one operative surface of the first electrode structure and to the insulated potentially active surface portion; wherein the critical distance is the maximum electrode spacing distance multiplied by a safety factor of at least 1.1.

In further aspect, there is provided a reactor system comprising: a plasma generator configured for effecting a plasma discharge into a reaction zone; a reaction vessel defining the reaction zone and configured for receiving reactant matter in the reaction zone, such that, while plasma is being discharged into the reaction zone by the plasma generator, at least a fraction of the reactant matter being provided in the reaction zone is converted into product matter, wherein the product matter includes solid particulate matter, wherein the reaction vessel comprises: an outlet configured for effecting discharge of the at least a fraction of the product matter from the reaction vessel; and an inclined wall surface portion substantially extending from the outlet and configured for directing at least a fraction of the solid particulate matter towards the outlet.

In further aspect, there is provided a method of operating a reactor including a reaction zone, comprising: effecting a plasma discharge in the reaction zone; contacting reactant matter with the plasma discharge such that a reactive process is effected to produce product matter including solid particulate matter; and while the reactive process is being effected, flowing a particulate uncoupling gaseous fluid flow to mitigate coupling of the produced product matter to the reactor or to effect uncoupling of the produced product matter which becomes coupled to the reactor.

In further aspect, there is provided a method of operating a reactor including a reaction zone, comprising an operating cycle which is repeated at least once, such that at least two executions of the operating cycle are provided, wherein the operating cycle is defined by a first predetermined time interval and a second predetermined time interval, wherein the second predetermined time interval commences upon completion of the first predetermined time interval; and wherein, during the first predetermined time interval, generation of a plasma discharge is effected by a plasma generator, and reactant matter is contacted with the plasma discharge such that a reactive process is effected to produce product matter including solid particulate matter which becomes physically coupled to at least a fraction of the plasma generator; and wherein, during the second predetermined time interval, particulate uncoupling gaseous fluid is flowed and effects uncoupling of at least a fraction of the coupled solid particulate matter; wherein substantially no particulate uncoupling gaseous fluid is flowed during the first predetermined time interval, and substantially no plasma discharge is effected during the second predetermined interval.

In further aspect, there is provided a method of operating a reactor system including a plasma generator, comprising: operating the reactor system in an experimental mode, including: generating a test plasma discharge by the plasma generator; contacting the test plasma discharge with test reactant matter, such that a reactive process is effected to produce test product matter including test solid particulate matter which becomes physically coupled to at least a fraction of the plasma generator; and measuring the rate of physical coupling of the solid particulate matter; and operating the reactor system in a normal operating mode, wherein the normal operating mode includes an operating cycle, wherein the operating cycle is defined by a first predetermined time interval and a second predetermined time interval, wherein the second predetermined time interval commences substantially after completion of the first predetermined time interval, and wherein the duration of the first predetermined time interval is based upon the measured rate of physical coupling of the solid particulate matter during the experimental mode; and wherein, during the first predetermined time interval, generation of a normal operation plasma discharge is effected by the plasma generator, and normal operation reactant matter is contacted with the normal operation plasma discharge such that a reactive process is effected to produce normal operation product matter including normal operation solid particulate matter which become physically coupled to at least a fraction of the plasma generator; and wherein, during the second time interval, particulate uncoupling gaseous fluid is flowed and effects uncoupling of at least a fraction of the coupled solid particulate matter; and wherein substantially no particulate uncoupling gaseous fluid is flowed during the first predetermined time interval, and substantially no plasma discharge is effected during the second predetermined time interval.

In further aspect, there is provided a reactor system comprising: a reaction vessel defining a reaction zone; a plasma generator configured for effecting a plasma discharge into a reaction zone, including: a current and voltage source; a first electrode structure physically coupled to the reaction vessel, and including at least one operative surface electrically coupled to the current and voltage source for effecting an electrical discharge; and a second electrode structure physically coupled to the reaction vessel, and including at least one operative surface configured for receiving the electrical discharge, wherein the second electrode structure is spaced apart from the first electrode structure, and the reaction zone is disposed between the first and second electrode structures; such that, when a plasma forming gaseous fluid is disposed within the reaction zone and a sufficient electrical potential difference is applied between a one of the at least one operative surface of the first electrode structure and a respective one of the at least one operative surface of the second electrode structure, an electrical discharge is effected between the one of the at least one operative surface of the first electrode structure and the respective one of the at least one operative surface of the second electrode structure and through the reaction zone, and at least a fraction of the plasma forming gaseous fluid is converted into the plasma discharge; wherein the second electrode structure is adjustably positionable relative to the first electrode structure.

In further aspect, there is provided a method of operating a plasma reactor comprising: providing a reaction vessel including a reaction zone, and also including an internal surface including a seating surface; generating a plasma in the reaction zone with a plasma generator, wherein the plasma generator includes: a current and voltage source; a first electrode structure physically coupled to the reaction vessel, and including at least one operative surface electrically coupled to the current and voltage source for effecting an electrical discharge; and a second electrode structure supported on the seating surface, and including at least one operative surface configured for receiving the electrical discharge, wherein the second electrode structure is spaced apart from the first electrode structure, and the reaction zone is defined between the first and second electrode structures; wherein, while the plasma forming gaseous fluid is disposed within the reaction zone, an electrical potential difference is applied between a one of the at least one first electrode operative surface of the first electrode structure and a respective one of the at least one second electrode operative surface of the second electrode structure by the current and voltage source so as to effect an electrical discharge between the one of the at least one first electrode operative surface of the first electrode structure and the respective one of the at least one second electrode operative surface of the second electrode structure and through the reaction zone to effect generation of the plasma from the plasma forming gaseous fluid; wherein, as the plasma is generated by the plasma generator, the second electrode structure becomes eroded, such that the spacing between the first and second electrodes increases as the plasma is generated by the plasma generator; and after the spacing between the first and second electrode structure has increased by a predetermined amount from an initial spacing, inserting at least one spacer between the second electrode structure and the seating surface, such that the second electrode structure assumes closer proximity to the first electrode structure.

In further aspect, there is provided a reactor system comprising: a reaction vessel defining a reaction zone and including an internal wall portion defining a seating surface; a plasma generator configured for effecting a plasma discharge into a reaction zone, including: a current and voltage source; a first electrode structure physically coupled to the reaction vessel, and including at least one operative surface electrically coupled to the current and voltage source for effecting an electrical discharge; and a second electrode structure physically coupled to the reaction vessel, and including at least one operative surface configured for receiving the electrical discharge, wherein the second electrode structure is spaced apart from the first electrode structure, and the reaction zone is disposed between the first and second electrode structures; such that, when a plasma forming gaseous fluid is disposed within the reaction zone and a sufficient electrical potential difference is applied between a one of the at least one operative surface of the first electrode structure and a respective one of the at least one operative surface of the second electrode structure, an electrical discharge is effected between the one of the at least one operative surface of the first electrode structure and the respective one of the at least one operative surface of the second electrode structure and through the reaction zone, and at least a fraction of the plasma forming gaseous fluid is converted into the plasma discharge; wherein the second electrode structure rests upon and is supported by the seating surface of the internal wall portion of the reaction vessel.

### BRIEF DESCRIPTION OF DRAWINGS

The system and method of the preferred embodiments of the invention will now be described with the following accompanying drawings:

FIG. 1 is a schematic illustration of an embodiment of a reaction system;

FIG. 2 is a schematic illustration of a sectional, front elevation view of a reaction vessel of the reactor system illustrated in FIG. 1;

FIG. 3 is a schematic illustration of a sectional, fragmentary, front elevation view of a reaction vessel illustrated in FIG. 2, illustrating a lower section of the reaction vessel and the fluid flow patterns of fluids for which the reaction vessel is configured to flow;

FIG. 4 is schematic illustration of a sectional, fragmentary, front elevation view of reaction vessel illustrated in FIG. 2, illustrating a lower section of the reaction vessel and the fluid flow patterns of fluids for which the reaction vessel is configured to flow, and also illustrating the plasma plume;

FIG. 4A is a sectional plan view of the reaction vessel illustrated in FIG. 2, taken along lines 4A-4A;

FIG. 5 is a schematic illustration of a sectional, front elevation view of another embodiment of a reaction vessel used in the reaction system of FIG. 1;

FIG. 6 is a schematic illustration of the second electrode of the reactor system illustrated in FIG. 1;

FIG. 7 is a schematic illustration of an embodiment of an electric circuit for effecting a high voltage power supply to the reactor system;

FIG. 8 is a schematic illustration of an embodiment of an electric circuit for effecting a co-ordinated operating cycle for the reactor system, whereby high voltage power is effected to the reactor system for a first predetermined time interval in response to a transmitted high voltage excitation signal, and flow of a particulate uncoupling gaseous fluid is effected for a subsequent second predetermined time interval in response to a burst gas excitation signal transmittal to a valve which controls the flow of the particulate uncoupling gaseous fluid;

FIG. 9 is a schematic illustration of typical waveforms for the high voltage excitation signal and the burst gas excitation signal;

FIGS. 10 to 13 are schematic illustrations of a sectional, front elevation view of a reaction vessel of the reactor system illustrated in FIGS. 1, and each one of the figures illustrates relative dispositions of certain elements of the reaction vessel;

FIG. 14 is a schematic illustration of a fragmentary, sectional front elevation view of a reaction vessel of the reactor system illustrated in FIG. 1, showing the “short carbon bridge condition”;

FIG. 15 is a schematic illustration of a fragmentary, sectional front elevation view of a reaction vessel of the reactor system illustrated in FIG. 1, showing the “long carbon bridge condition”;

FIG. 16 is sectional, front elevation view of another embodiment of a reaction vessel of the reactor system illustrated in FIG. 1;

FIG. 17 is an enlarged view of Detail “C” in FIG. 16;

FIG. 18 is a side elevation view of a high voltage feed through connector, and including a high voltage pin;

FIG. 19 is a sectional side elevation view of the components illustrated in FIG. 18;

FIG. 19A is a schematic illustration of a cable assembly;

FIG. 20 is a side elevation view of a crimp contact;

FIG. 21 is a front elevation view of another embodiment of a reaction vessel of the reactor system illustrated in FIG. 1; and

FIG. 22 is a sectional, side elevation view of the reaction vessel illustrated in FIG. 21, taken along lines A-A.

### DETAILED DESCRIPTION OF PREFERRED EMBODIMENTS OF THE INVENTION

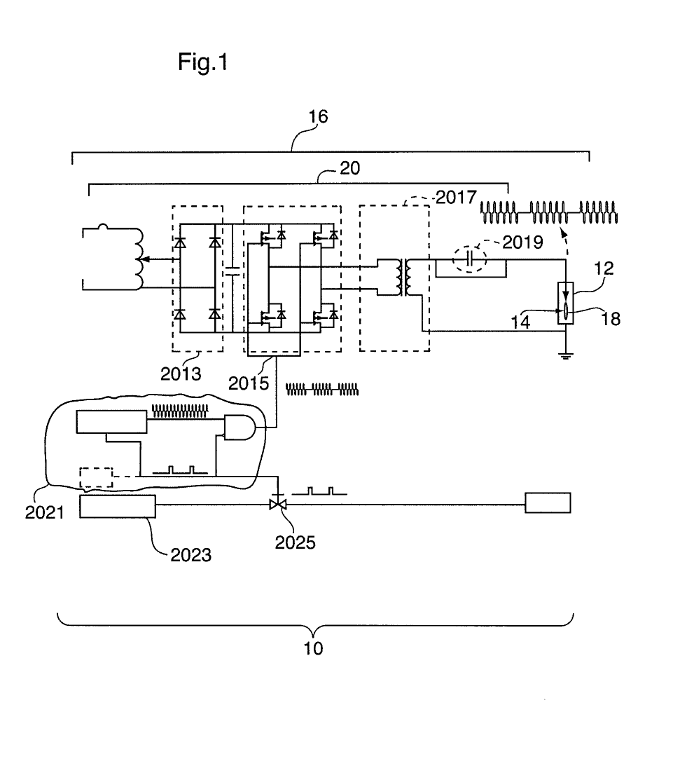

Referring to FIG. 1, there is provided a reactor system 10 including a reaction vessel 12, including a reaction compartment 141 which includes a reaction zone 14, and a plasma generator 16 configured for effecting a plasma discharge into the reaction zone 14. For example, the plasma discharge into the reaction zone 14 is a plasma plume 18.

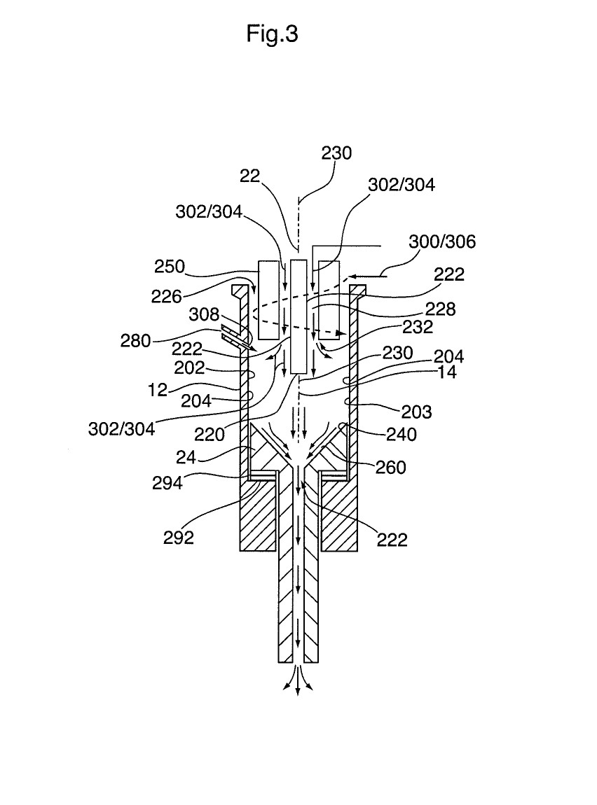

For example, and referring to FIGS. 1, 2, 3, and 8, with respect to the plasma generator 16, the plasma generator 16 includes a current and voltage source 20, a first electrode structure 22, and a second electrode structure 24.

The first electrode structure 22 is coupled to the reaction vessel 12. The first electrode structure 22 includes at least one operative surface 220 electrically connected to the current and voltage source 20 for effecting an electrical discharge.

The second electrode structure 24 is attached to, or forms part of the reaction vessel 12, and includes at least one operative surface 240 configured to function as the ground electrode in the electrical discharge. The second electrode structure 24 is spaced apart from the first electrode structure 22, and the reaction zone 14 is disposed between the first and second electrode structures 22, 24.

The first and second electrode structures 22, 24 co-operate such that, when a plasma forming gaseous fluid is disposed within the reaction zone 14 and a sufficient electrical potential difference is applied between a one of the at least one operative surface 220 of the first electrode structure 22 and a respective at least one of the at least one operative surface 240 of the second electrode structure 24, an electrical discharge is effected between a one of the at least one operative surface 220 of the first electrode structure 22 and the respective one of the at least one operative surface 240 of the second electrode structure 24 and through the reaction zone 14, and at least a fraction of the plasma forming gaseous fluid in the reaction zone 14 is converted by the electric discharge into a plasma state (or, simply, “plasma”) by the action of the electric discharge.

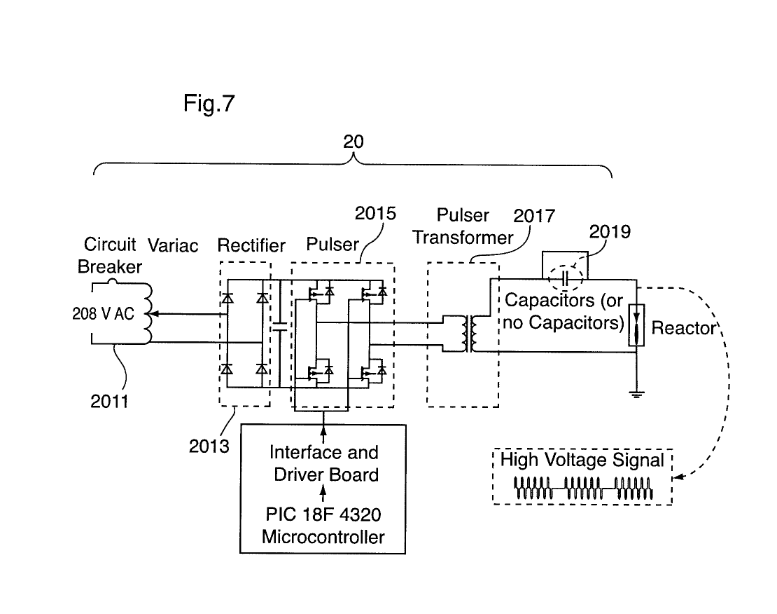

For example, with respect to the current and voltage source 20, the frequency of the current and voltage source is from 10 KHz to 20 KHz, and the pulse width of the current and voltage source is from 10 to 20 micro-seconds. An exemplary electrical circuit for effecting a high voltage power supply to the electrode structures 22, 24 is illustrated in FIG. 7. The first electrode structure 22 is electrically connected to a power supply 2011. The power supply 2001 includes a rectifier 2013, a pulser 2015 (or inverter), a high voltage pulse transformer 2017, and, optionally, high voltage capacitors 2019 connected in series with the secondary winding of the pulse transformer 2017. The high voltage capacitors 2019 function in multi-discharge generation and for impedance matching, and, in this respect, allow simultaneous powering of multiple electrodes by a single power source, such as various embodiments of the reactor which are described and illustrated in Canadian Patent Application No. 2,516,499 which is herein incorporated by reference in its entirety. The high voltage capacitors 2019 can be omitted under single discharge conditions. The power supply provides controlled bipolar high voltage pulses to a high voltage transformer which acts as a filter to make the current almost sinusoidal. For example, switching frequencies are between 10 kHz to 20 kHz, such as between 15 kHz to 17 kHz. For example, the pulse widths are between 10 to 20 microseconds, such as between 15 to 17 microseconds. For example, in operation, a stable flow of plasma forming gaseous fluid is established through the reactor vessel 12, and once substantially all of the ambient air has been purged from the reaction vessel 12, a high voltage pulse is supplied to the first electrode structure 22, and plasma is created in the reaction zone 14 between the electrode structures 22, 24.

For example, with respect to the first and second electrode structures 22, 24, each one of these structures is electrically conductive and is configured to operate robustly in high temperature conditions.

For example, with respect to the first electrode structure 22, the first electrode structure is a lanthanated tungsten rod. Other examples of suitable materials for the first electrode structure include substantially pure tungsten, 2% thoriated tungsten, tungsten carbide, and other tungsten alloys.

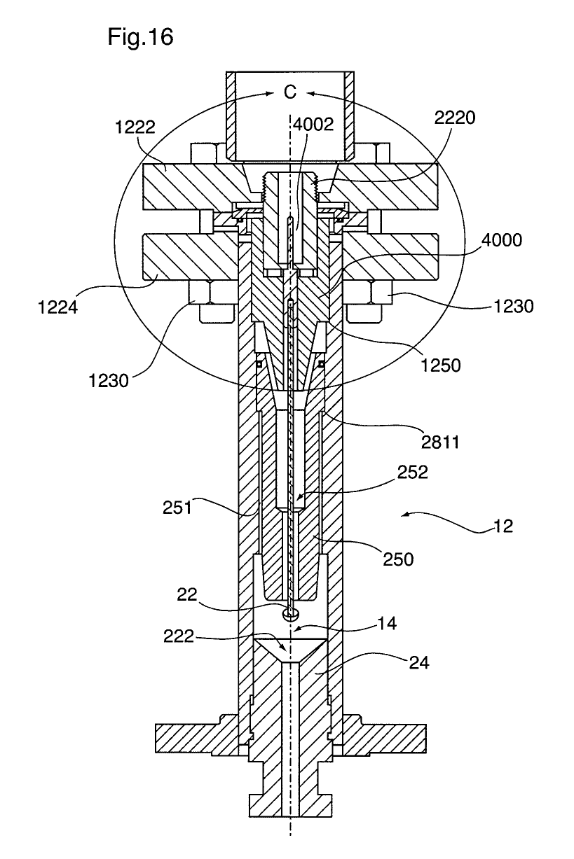

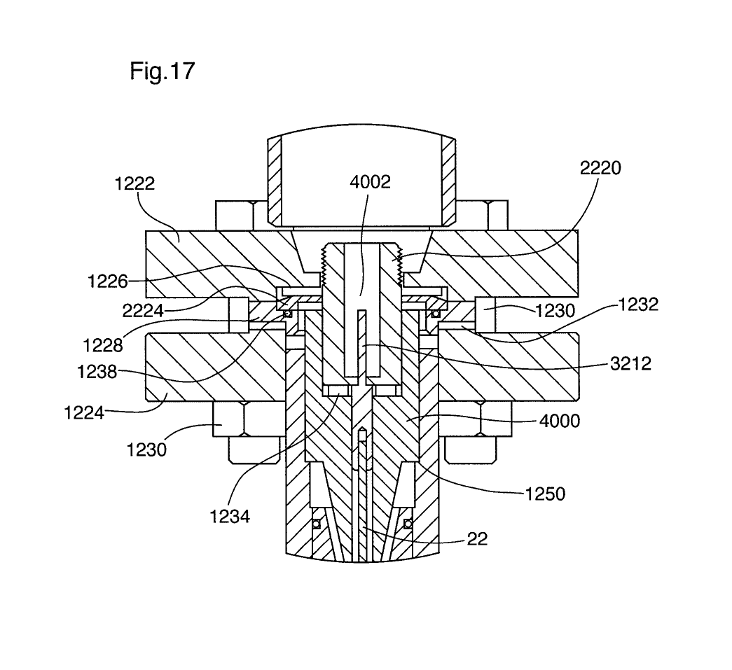

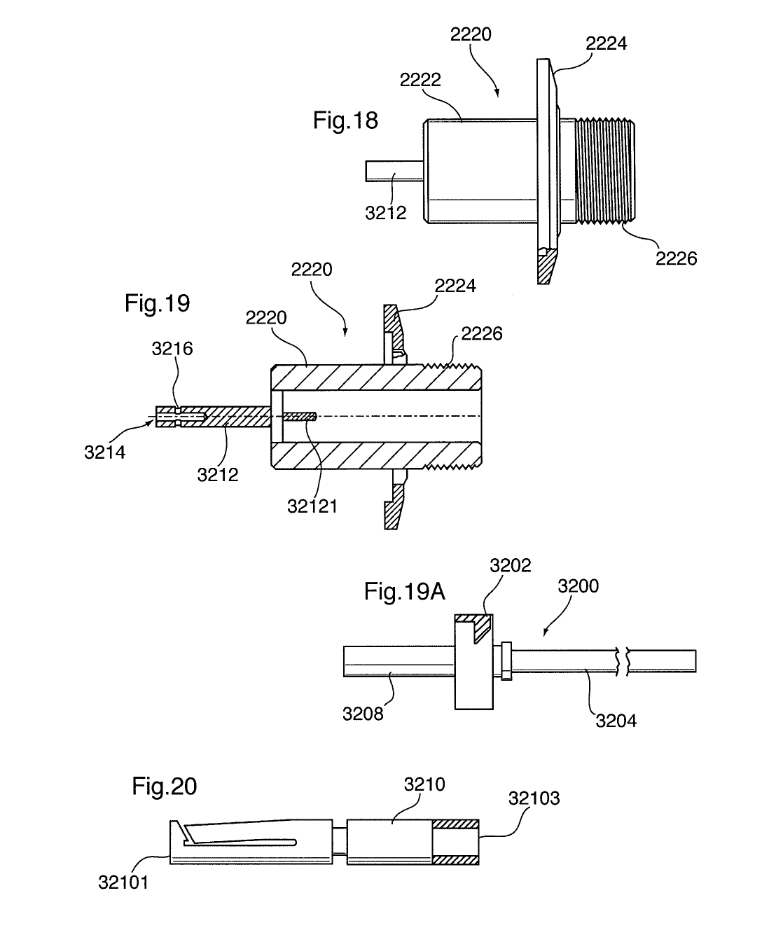

Referring to FIGS. 16 to 22, for example, the first electrode structure 22 is electrically coupled to the voltage and power source 20 through a high voltage feedthrough assembly. The feedthrough assembly includes a high voltage feedthrough connector 2220. The connector 2220 is coupled to the reaction vessel 12. A suitable connector 2220 is illustrated in FIG. 17. For example, a suitable connector 2220 is CeramTec High Voltage Feedthrough Part Number 21185-01-KF available from CeramTec North America Corporation (see www2.ceramtec.com) and rated for 50 kV DC, 10 A, and 400 psig. For example, the pin of the CeramTec High Voltage Feedthrough Part Number 21185-01-KF is modified such that the pin is made thicker to facilitate coupling to the first electrode structure 22. For example, the connector 2220 is mounted between upper and lower flanges 1222, 1224 of the reaction vessel 12. Referring to FIGS. 18 and 19, the connector 2220 includes a housing 2222 formed from KAVOR™, and a stainless steel flange 2224 peripherally extending from the housing 2222. The flange 2224 is pressed between a compression disc 1226 and a sealing plate 1228. The compression disc 1226 is a rubber washer which functions as a buffer to provide a relatively uniformly distributed compression across a surface of the flange 2224 of the connector 2220, the compression being generated by the bolts 1230 which join the upper and lower flanges 1222, 1224. The sealing plate 1228 is a stainless steel plate disposed between the lower flange 1224 and the flange 2224 of the connector 2220. A mica gasket 1232 is disposed between the sealing plate 1228 and the lower flange 1224, and functions as a mechanical seal to prevent leakage from between the plate 1228 and the flange 1224. Compression ring 1234 and o-ring 1238 are also provided to mitigate or prevent leakage between components. Referring to FIG. 19A, a cable assembly 3200 is provided. The cable assembly 3200 includes a cap 3202 which is internally threaded. The cap 3202 is threadably coupled to the external threads 2226 provided on the connector 2220. The cable assembly 3200 further includes a high voltage cable 3204 which is electrically connected to a high voltage pin assembly which is disposed in a high voltage pin compartment 3208 (for example, made of silicone rubber) of the cable assembly 3200. The high voltage pin assembly 3208 includes a crimp contact 3210 (see FIG. 20), made from a nickel alloy, and a high voltage pin 3212, made from cold rolled steel (nickel plated). One end 32103 of the crimp contact 3210 is coupled to the cable 3204. One end 32121 of the high voltage pin 3212 is press-fit into and extends from one end 32101 of the crimp contact 3210. The cable 3204 is coupled (for example, soldered) to an opposite end of the crimp contact 3210 and is thereby electrically connected to the pin 3212. The pin 3212 includes a receptacle 3214 which receives the first electrode structure 22. A throughbore 3216 is provided in the pin 3212 to facilitate coupling of the first electrode structure 22 to the pin 3212 with a set screw. To effect insulation of the first electrode structure 22 from the reaction vessel wall, at least portions of which are made of electrically conductive material (such as stainless steel), an insulator 4000 is provided. For example, the insulator 4000 is made from Macor™ supplied by Corning Incorporated. The insulator 4000 includes a passage 4002 which is configured to receive disposition of the high voltage feedthrough assembly such that the first electrode structure 22 extends into the reaction zone 14. The insulator 4000 is supported on an internal shoulder 1250 extending from an internal surface of a wall of the reaction vessel 12. The insulator 4000 is also configured to support o-rings to facilitate sealing functions.

For example, with respect to the second electrode structure 24, the second electrode structure is made from a stainless steel. Other examples of suitable materials include lanthanated tungsten, substantially pure tungsten, 2% thoriated tungsten, tungsten carbide, other turgsten alloys, graphite, or silicon carbide.

For example, with respect to the plasma forming gaseous fluid, the plasma forming gaseous fluid is any one of those fluids that can be ionized through electron impact events within a voltage potential gradient, and thereby create a reduced impedance pathway that provides a current path. Any ionisable fluid can form a plasma provided that a sufficient potential gradient exists. Such ionisable fluids include, but are not limited to, elemental species such as the noble gases (He, Ne, Ar, etc.), molecular gases (i.e. H₂, O₂, O₃, CH₄, CF₄, SF₆, H₂S, etc.) and vaporizable organic liquids (i.e. butane, hexane), organometallic liquids (i.e. tetaethoxysilane, trimethylphosphine, etc) and inorganic liquids (water, TiCl₄). For example, the plasma forming gaseous fluid includes no gaseous oxygen or substantially no gaseous oxygen.

For example, with respect to the reaction vessel 12, the reaction vessel 12 includes an inlet 232 configured for introducing the plasma forming gaseous fluid flow 304 to the plasma generator 16 so as to effect the plasma discharge into the reaction zone 14 by the plasma generator 16 such that the plasma discharge facilitates conversion of reactant matter in the reaction zone 14 into product matter.

As a further example with respect to the reaction vessel 12, the reaction vessel 12 is configured for receiving reactant matter within the reaction zone 14. For example, the reactant matter is in the form of a fluid, such as a gaseous fluid, and the reactor vessel 12 includes the inlet 232 for introducing reactant matter fluid as reactant matter fluid flow 302 into the reaction zone 14. In the illustrated embodiment, the inlet for the plasma forming gaseous fluid flow is the same as the inlet for the reactant matter fluid flow as the plasma forming gaseous fluid is the same as the reactant matter fluid. For example, the plasma forming gaseous fluid flow, when it is the same as the reactant matter fluid flow, is introduced through the inlet at a flow rate of 3.5 cubic metres per hour. For example, the inlet 232 includes an inlet axis 2321. For example, the reaction vessel 12 includes a fluid passage 228, and the fluid passage 228 is configured for flowing the plasma-forming gaseous fluid (in some embodiments, the plasma-forming gaseous fluid is the same as the reactant matter fluid) to the inlet 232 to effect its introduction into the reaction zone 14. The fluid is supplied to the fluid passage 228 through a reaction vessel inlet 237.

For example, with respect to the reactant matter, the reactant matter consists of any one of: (i) an element, (ii) a compound, (iii) a homogeneous or inhomogeneous mixture of any one of: (a) at least two elements, or (b) at least two compounds, or (iv) a homogeneous or inhomogeneous mixture of any combination of: (a) at least one element, and (b) at least one compound.

As a further example, with respect to the reactant matter, the reactant matter, which is suitable for conversion within the plasma generated by the plasma generator 16 includes gaseous and liquid hydrocarbons such as natural gas, volatile petroleum fractions, landfill and other bio-generated fuel gases, methane, ethane, propane, propene, butane, pentane, and hexane, and volatile oxygenated organic compounds such as methanol, and ethanol, and reactive molecular element species such as, but not limited to, hydrogen, oxygen and ozone, and volatile incrganic hydrides such as, but not limited to, H₂S, SiH₄, PH₃ , and AsH₃. At least a fraction of the reactant matter is subjected to a reactive process in the plasma generated by the plasma generator 16, such that the reactive process effects creation of product matter.

For example, with respect to the product matter, the product matter includes solid particulate matter. For example, with respect to the solid particulate matter of the product matter, at least a fraction of the solid particulate matter of the product matter becomes coupled to an internal structural surface 202 of the reaction vessel 12. The solid particulate matter is said to be coupled to the surface 202 when the solid particulate matter adheres to the surface 202 or becomes associated with solid matter which is already adhered to the surface 202. Mechanisms for association of the solid particulate matter with the solid matter adhered to the surface 202 include absorption, dissolution, covalent bonding, or ionic bonding. The operative forces, whose action effects the adhesion or the association, include any one of, or any combination of, Van der Waals adhesive forces, electrostatic forces, and gravity.

For example, with respect to the plasma forming gaseous fluid, the plasma forming gaseous fluid includes the reactant matter. In this respect, for example, the plasma forming gaseous fluid includes any of the suitable reactant matter described above.

As a further example, with respect to the plasma forming gaseous fluid including the reactant matter, a suitable plasma forming gaseous fluid is natural gas, typically including 70 mole % to 95 mole % methane, based on the total number of moles of plasma forming gaseous fluid, with small amounts of other hydrocarbons such as ethane and propane and varying levels of inert gases such as nitrogen and contaminant gases such as hydrogen sulphide. For example, these fluids are introduced into the plasma reactor at flows that can vary between very low (10's of cc/min) to very high (10's of Nm³/min). The plasma forming gaseous fluid is provided within the reaction zone 14. For example, natural gas feed flows to the reactor ranges between 3 Nm³/hr and 10 Nm³/hr. For example, the reaction is carried out at pressures that may range from medium vacuum (100's of Ton) to atmospheric and moderately high pressures (i.e. up to 15-20 psig). In this respect, for example, the reaction is carried out at a pressure of less than 20 psig. For example, the reactor is unheated. For example, once the plasma has been initiated, the system temperature is allowed to equilibrate to accommodate the small zone of very high (1000-1500° C.) temperature in the plasma plume. For example, reactor wall temperatures may be as high as 500° C. Depending on the reactant matter, the reactant matter of the plasma forming gaseous fluid is converted in the reaction zone 14 in accordance with any one of or any combination of the reaction steps described in Appendix “A”.

In this respect, the conversion of the reactant matter of the plasma forming gaseous fluid results in product matter including solid particulate matter, wherein the solid particulate matter includes carbon.

For example, the reaction vessel 12 includes an outlet 222 configured for discharging the product matter, and also includes a heat exchanger 224 disposed in thermal communication with the outlet 222 and configured for effecting heat transfer from the product matter discharging through the outlet 222. Such heat transfer effects cooling of the discharging product matter. For example, such heat transfer could effect heating of the plasma forming gaseous fluid before the plasma-forming gaseous fluid is introduced into the reaction vessel 12. In this respect, the heat exchanger is configured to receive the plasma-forming gaseous fluid and effect heat transfer from the discharging product matter and to the plasma-forming gaseous fluid.

### A. Reactor System Aspect for Effecting Vortical Flow

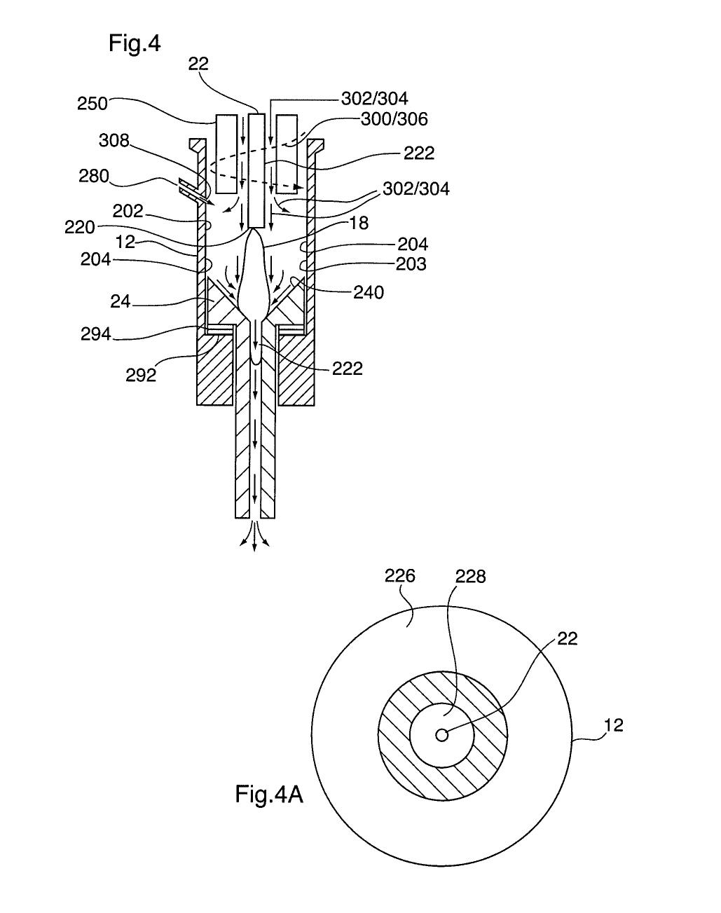

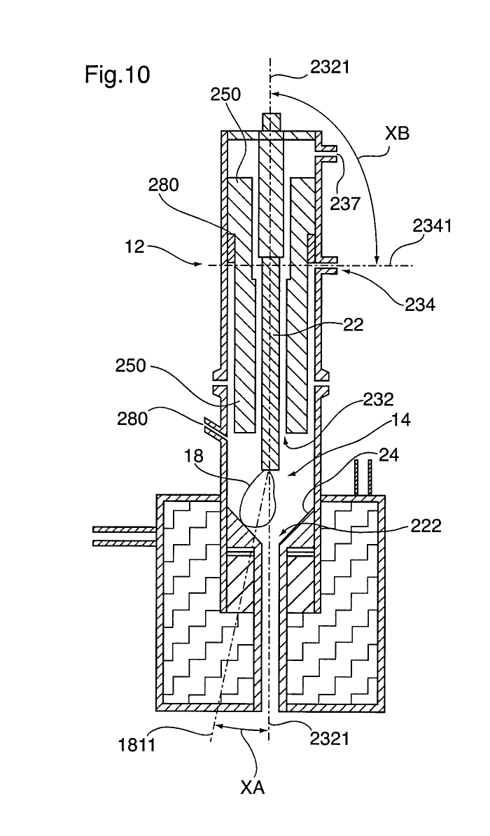

Referring to FIGS. 1, 2, 3, and 4, any of the above-described embodiments of the reactor system 10 is configured to mitigate against discharge of unreacted reactant matter from the reaction vessel 12. In this respect, the reactor system 10 is configured for effecting vortical flow 300 of a stabilizing gaseous fluid to effect desired positioning of the plasma plume 18. In this respect, the reaction vessel 12 includes a reaction vessel inlet 234 which is configured for introducing the stabilizing gaseous fluid tangentially relative to a wall surface portion 236 of the reaction compartment 141 For example, with respect to the introduction of the stabilizing gaseous fluid through the inlet 234, the introduction of the stabilizing gaseous fluid through the inlet 234 effects the vortical flow 300 of the stabilizing gaseous fluid such that the vortical flow 300 of the stabilizing gaseous fluid effects a spatial disposition of the plasma plume 18 such that at least a fraction of the gaseous reactant fluid flow 302 intersects the plasma plume 18. As a further example, with respect to the introduction of the stabilizing gaseous fluid through the inlet 234, the introduction of the stabilizing gaseous fluid through the inlet 234 effects the vortical flow 300 of the stabilizing gaseous fluid such that the vortical flow 300 of the stabilizing gaseous fluid effects a spatial disposition of the plasma plume 18 such that the axis 2321 of the inlet 232 intersects the plasma plume 18. As a further example, and referring to FIG. 10, with respect to the introduction of the stabilizing gaseous fluid through the inlet 234, the plasma plume includes a longitudinal axis 1811, and the introduction of the stabilizing gaseous fluid through the inlet 234 effects the vortical flow 300 of the stabilizing gaseous fluid such that the vortical flow 300 of the stabilizing gaseous fluid effects a spatial disposition of the plasma plume 18 such that the axis 2321 of the inlet 232 is disposed at an acute angle XA of less than 27 degrees relative to the axis 1811 of the plasma plume 18. For example, the axis 2321 is substantially co-located with the axis 1811. As a further example, with respect to the introduction of the stabilizing gaseous fluid through the inlet 234, the introduction of the stabilizing gaseous fluid through the inlet 234 effects a spatial disposition of the vortical flow 300 of the stabilizing gaseous fluid relative to the plasma plume 18 such that vortical flow 300 is disposed substantially peripherally relative to the plasma plume 18.

For example, and referring to FIG. 10, with respect to the spatial disposition of the inlet 234, the inlet 234 includes an inlet axis 2341, and the inlet axis 2341 is transverse to the axis 2321 of the inlet 232. For example, the axis 2341 is disposed at an acute angle XB of less than 30 degrees relative to the axis 2321. For example, the axis 2341 is disposed at an acute angle XB of less than 15 degrees relative to the axis 2321. For example, the axis 2341 is substantially perpendicular relative to the axis 2321.

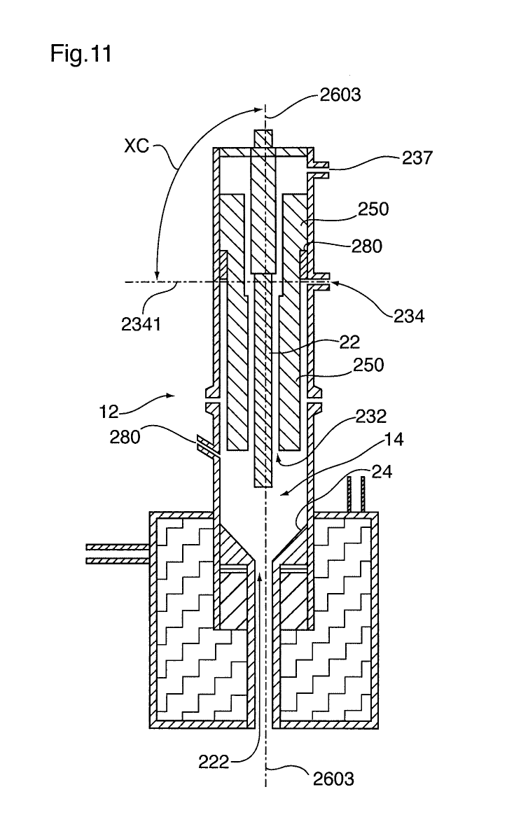

For example, and referring to FIG. 11, the outlet 222 includes the axis 2603. The axis 2341 is transverse to the axis 2603. For example, the axis 2341 is disposed at an acute angle XC of less than 30 degrees relative to the axis 2603. For example, the axis 2341 is disposed at an acute angle XC of less than 15 degrees relative to the axis 2603. For example, the axis 2341 is substantially perpendicular to the axis 2603. For example, the axis 2603 is substantially co-located with the axis 2321.

For example, with respect to the reaction compartment 141, the reaction compartment 141 includes a frusto-conical wall portion 2601 substantially extending from the outlet 222, and the outlet 222 includes the axis 2603.

For example, the reaction vessel 12 further includes an annular fluid passage 226 configured for effecting any of the above-described embodiments of the vortical flow 300. The annular fluid passage 226 is disposed peripherally relative to the inlet 232. For example, the annular fluid passage is disposed radially relative to the inlet axis 2321. The inlet 234 discharges into the annular fluid passage 226. The annular fluid passage 226 receives the stabilizing gaseous fluid introduced through the inlet 234 and includes an outlet 235 for effecting the discharge of the stabilizing gaseous fluid into the reaction compartment 141 to effect the vortical flow 300. For example, with respect to the effected vortical flow 300, the effected vortical flow 300 of the stabilizing gaseous fluid effects a spatial disposition of the plasma plume 18 such that at least a fraction of the gaseous reactant fluid flow 302 intersects the plasma plume 18. As a further example, with respect to the effected vortical flow 300, the effected vortical flow 300 of the stabilizing gaseous fluid effects a spatial disposition of the plasma plume 18 such that the axis 2321 of the inlet 232 intersects the plasma plume 18. As a further example, and referring to FIG. 10, with respect to the effected vortical flow 300, the effected vortical flow 300 of the stabilizing gaseous fluid effects a spatial disposition of the plasma plume 18 such that the axis 2321 of the inlet 232 is disposed at an acute angle XA of less than 27 degrees relative to the axis 1811 of the plasma plume 18. For example, the axis 2321 is substantially co-located with the axis 1811. As a further example, with respect to the effected vortical flow 300, the effected vortical flow 300 is disposed substantially peripherally relative to the plasma plume 18.

For example, with respect to the annular fluid passage 226, the annular fluid passage 226 is defined between: (i) a sidewall 121 of the reaction vessel 12, the sidewall 121 including one or more of a plurality of potentially active surface portions 204 (described in further detail below), and (ii) the insulator 250 (the insulator 250 is also described in further detail below, including its relationship with the first electrode structure 22 and the plurality of potentially active surface portions 206).

For example, with respect to the stabilizing gaseous fluid, the stabilizing gaseous fluid includes substantially the same composition as the plasma-forming gaseous fluid and/or the reactant matter fluid.

There is also provided a method of operating a reaction system 10 including: generating a plasma plume 18, flowing a reactant fluid flow 302 into a reaction zone 14, and effecting a spatial disposition of the plasma plume 18 with the vortical flow 300 of a stabilizing gaseous fluid such that the reactant fluid flow 302 intersects the plasma plume 18. For example, with respect to the plasma forming gaseous fluid, the ratio of the volumetric flow of the plasma forming gaseous fluid flow 304 to the volumetric flow of the stabilizing gaseous fluid flow 300 is at least 1:1. For example, the ratio is 3.5:1.5. For example, with respect to the vortical flow 300, the vortical flow 300 of the stabilizing gaseous fluid effects a spatial disposition of the plasma plume 18 such that at least a fraction of the gaseous reactant fluid flow 302 intersects the plasma plume 18. As a further example, with respect to the vortical flow 300, the vortical flow 300 of the stabilizing gaseous fluid effects a spatial disposition of the plasma plume 18 such that the axis 2321 of the inlet 232 intersects the plasma plume 18. As a further example, and referring to FIG. 10, with respect to the vortical flow 300, the vortical flow 300 of the stabilizing gaseous fluid effects a spatial disposition of the plasma plume 18 such that the axis 2321 of the inlet 232 is disposed at an acute angle of less than 27 degrees relative to the axis 1811 of the plasma plume 18. For example, the axis 2321 is substantially co-located with the axis 1811. As a further example, with respect to the vortical flow 300, the vortical flow 300 is disposed substantially peripherally relative to the plasma plume 18. For example, with respect to the plasma plume 18, at least a fraction of the plasma plume 18 is disposed internally within the vortical flow 300 of the stabilizing gas. Also, as a further example with respect to the plasma plume 18, the at least a fraction of the plasma plume 18 is 0.3.

### B. Reactor System Aspect for Mitigating Plasma Discharge Between Electrode and an INternal Structural Surface of the Reaction Vessel

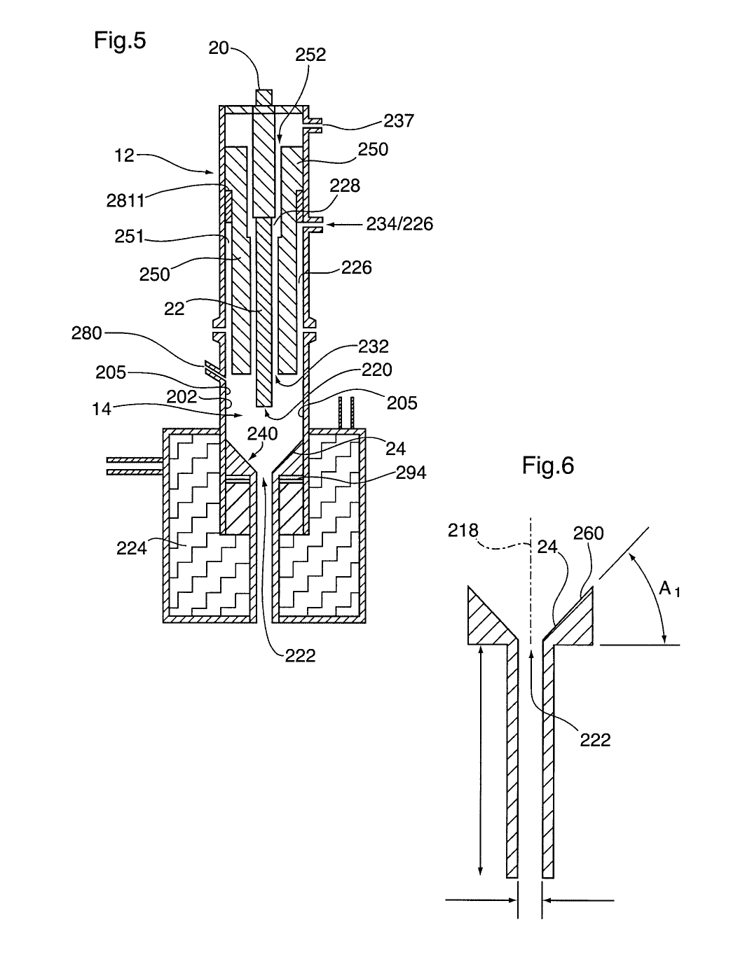

Referring to FIGS. 1, 2, 3, 4 and 5, in another aspect, for the reactor system 10 including the plasma generator 16, wherein the plasma generator 16 includes the current and voltage source 20, the first electrode structure 22, and the second electrode structure 24, the reactor system 10 is configured for mitigating plasma discharge between the first electrode structure 22 and an internal structural surface 202 of the reaction vessel 12.

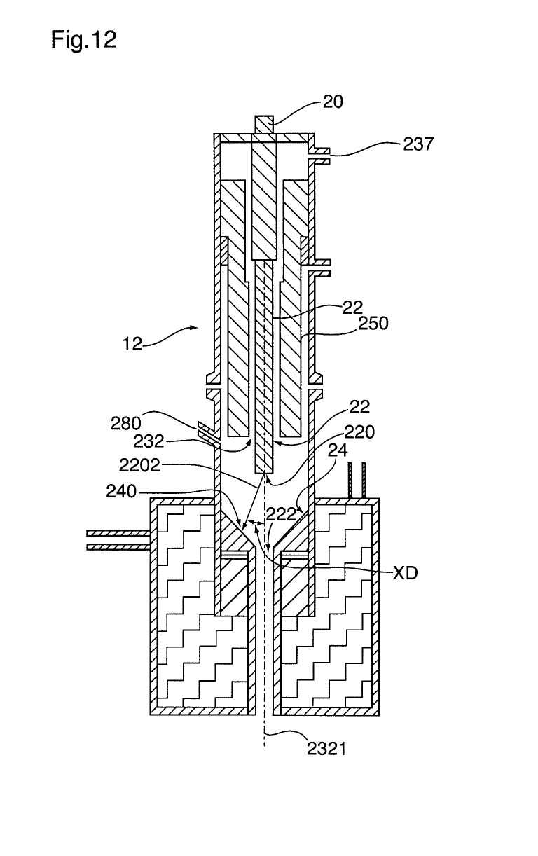

Each one of the at least one operative surface 220 of the first electrode structure 22 is spaced apart from each one of the at least one operative surface 240 of the second electrode structure 24 by a respective linear distance which is a respective electrode spacing distance. The respective electrode spacing distance by which a one of the at least one operative surface 220 is spaced apart from at least one of the at least one operative surface 240 is a minimum electrode spacing distance, and each one of the other ones of the at least one operative surface 220 is spaced apart from each one of the at least one operative surface 240 by a respective other linear distance which is a respective other electrode spacing distance, wherein the respective other electrode spacing distance is greater than or equal to the minimum electrode spacing distance. For example, and referring to FIG. 12, the respective other electrode spacing distance by which at least one of the other ones of the at least one operative surface 220 is spaced apart from at least one of the at least one operative surface 240 is a maximum electrode spacing distance. For example, each one of the at least one operative surface 220 is connected to a respective one of each one of the at least one operative surface 240 by a respective ray, and the respective ray 2202 is disposed at an acute angle XD of less than 51 degrees relative to the axis 2321 of the inlet 232.

The reaction vessel 12 includes an internal structural surface 202 fluidly communicating with the reaction zone 14. The internal structural surface 202 includes a plurality of surface portions 203, such that each one (or substantially each one) of those surface portions 203 of the internal structural surface 202 which are spaced apart from each one of the at least one operative surface 220 of the first electrode structure 22 by a respective linear distance, wherein a respective operative spacing distance, wherein the respective operative spacing distance is greater than a critical distance, is at least one of:

(a) defined by a substantially non-conducting material, or

(b) disposed relative to an insulator 250, provided within the reaction vessel 12, and is thereby defined as an insulated potentially active surface portion 204b, such that the insulator 250 is disposed between the insulated potentially active surface portion 204b and each one of the at least one operative surface 220 of the first electrode structure 22, wherein the insulator 250 prevents or substantially prevents electric discharge between substantially each one of the at least one operative surface 220 of the first electrode structure 22 and to the insulated potentially active surface portion 204b.

For example, the critical distance is the maximum electrode spacing distance multiplied by a safety factor of at least 1.1. For example, the critical distance is the maximum electrode spacing distance multiplied by a safety factor of at least 1.25. For example, the critical distance is the maximum electrode spacing distance multiplied by a safety factor of at least 1.35. As a further example, the critical distance is the maximum electrode spacing distance. As a further example, the critical distance is the minimum electrode spacing distance.

Where at least one of the plurality of potentially active surface portions 204 is disposed relative to an insulator 250, such that each one of the at least one of the potentially active surface portions 204 is thereby defined as an insulated potentially active surface portion 204b, there is provided at least one insulated potentially active surface portion 204b. For example, each one of the at least one insulated potentially active surface portion 204b is defined by an electrically conducting surface, such as stainless steel.

Substantially non-conducting material is a material which is electrically non-conductive and has a temperature rating of greater than 80 degrees Celsius. Such materials include, but are not limited to, ceramic coatings and/or glazing, or Macor™ quartz tubing.

For example, with respect to the insulator 250, the insulator 250 is disposed between each one of the at least one operative surface 220 of the first electrode structure 22 and a respective one of each one of the at least one insulated potentially active surface portions 204b. For example, the insulator 250 is spaced apart from at least a fraction of the plurality of potentially active surface portions 204 such that an annulus 251 is defined between the surface portions 204 and the insulator 250. The annulus 251 is provided to mitigate the formation of a carbon bridge between the insulator 250 and at least a fraction of the at least one insulated potentially active surface portions 204b. For example, the spacing of the insulator 250 from each one of the plurality of potentially active surface portion 204b includes a minimum spacing of at least 0.05 inches. For example, the minimum spacing is at least 0.1 inches. For example, at least a portion of annulus 251 is co-located with the fluid passage 226.

For example, with respect to the insulator 250, the insulator 250 defines a bore 252 and at least a fraction of the first electrode structure 22 is disposed within the bore 252. In the embodiment illustrated, a substantial fraction of the first electrode structure is disposed within the bore 252. By being disposed within the bore 252, electrical discharge between the first electrode structure and each one of the at least one insulated potentially active surface portion 204b is prevented or substantially prevented. For example, with respect to the bore 252, at least a fraction of the bore 252 also functions as the fluid passage 228.

For example, with respect to the insulator 250, the insulator is fabricated from a machinable ceramic such as Macor™, various mica products, quartz, and/or alumina.

For example, the insulator 250 is supported on a shoulder 2811 extending from an internal wall portion of the reaction vessel 14.

C. Reactor System Aspect for Effecting Discharge of Solid Particulate Material from Reaction Vessel

Referring to FIGS. 1, 2, 3, 4, and 6, in another aspect, for the reactor system 10 including the plasma generator 16, wherein the plasma generator 16 includes the current and voltage source 20, the first electrode structure 22, and the second electrode structure 24, the reactor system 10 is configured for effecting discharge of solid particulate material from the reaction vessel 12.

As discussed above, conversion of at least a fraction of the reactant matter produces product matter including solid particulate matter. In order to effect discharge of at least a fraction of the produced solid particulate matter from the reaction vessel 12, the reaction vessel includes an inclined surface portion 260 which substantially extends from the outlet 222 of the reaction vessel 12, and at least a portion of the inclined wall surface portion 260 defines the second electrode structure 24. The inclined wall surface portion 260 is configured for directing at least a fraction of the solid particulate matter towards the outlet 222.

For example, with respect to the inclined wall surface portion 260, the inclined wall surface portion 260 is substantially inclined at an angle A₁ of less than 75 degrees relative to the axis 218 of the outlet 222 (see FIG. 6). For example, the angle A₁ is 45 degrees relative to the axis of the outlet. “Substantially inclined at an angle A₁”, in relation to the inclined wall surface portion 260, means that the inclined wall surface portion 260 is either: (a) inclined, in the manner described, continuously, across the entire portion 260, or (b) inclined, in the manner described, across substantially the entire portion 260, but not continuously across the entire portion 260, and, in this respect, the portion 260 includes one or more surface sections which are not inclined relative to the axis 218 or are inclined relative to the axis 218 at an angle which is greater than A₁, but the one or more surface sections, either alone or in combination, do not impede, or do not substantially impede, the directed flow of the at least a fraction of the solid particulate matter across the portion 260 and to the outlet 222. For example, the inclined wall surface portion 260 is defined by a frustoconical wall surface portion 260, which substantially extends from the outlet 222.

For example, with respect to the outlet 222, the outlet 222 is configured to be disposed below the reaction zone 14.

D. Reactor System Aspect for Mitigating Coupling of Solid Particulate Matter to an Internal Structural Surface within the Reaction Vessel

Referring to FIGS. 1, 2, 3 and 4, in another aspect, there is provided a method of operating a reactor system 10 for one of: (i) mitigating coupling of solid particulate matter to an internal structural surface 202 disposed in fluid communication with the reaction zone 14, or (ii) uncoupling solid particulate matter from an internal structural surface 202 disposed in fluid communication with the reactor zone 14, or both (i) and (ii). The reactor system 10 includes the reaction vessel 12 defining a reaction zone 14 and a plasma generator 16 for effecting a plasma discharge in the reaction zone. The plasma discharge is generated by the plasma generator 16. Reactant matter is contacted with the plasma discharge in the reaction zone such that a reactive process is effected to produce product matter. The product matter includes solid particulate matter. For example, at least a fraction of the solid particulate matter of the product matter becomes coupled to at least a fraction of the internal structural surface 202.

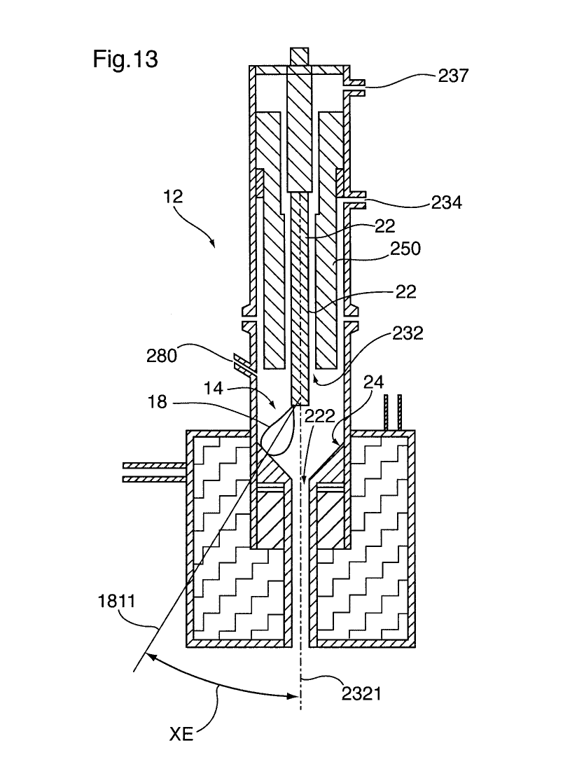

An exemplary purpose of one of: (i) mitigating coupling of solid particulate matter to an internal structural surface 202 disposed in fluid communication with the reaction zone 14, or (ii) uncoupling solid particulate matter from an internal structural surface 202 disposed in fluid communication with the reactor zone 14, or both (i) and (ii), is for mitigating against the generation of the plasma plume 18 in an undesirable location. Coupling of the solid particulate matter to the internal structural surface 202 during the above-described reactive process effects the formation of a solid particulate matter layer 2021 on the internal structural surface 202. The solid particulate matter layer 2021 includes a plurality of potentially active solid particulate matter layer surface portions 20211. Each one of the plurality of potentially active solid particulate matter surface portions 20211 is spaced apart from each one of the at least one operative surface 220 of the first electrode structure 220 by a respective linear distance which is a respective potentially operative spacing distance 20213, such that a plurality of respective potentially operative spacing distances 20213 are provided. As the reactive process continues, the physical coupling of the solid particulate matter to the internal structural surface 202 also continues (through association of new solid particulate matter with the solid particulate matter already adhered to the internal structural surface 202, as described above), effecting accumulation of the coupled solid particulate matter and the growth of the solid particulate matter layer 2021. As the solid particulate matter layer 2021 grows, there is a risk that at least one of the plurality of respective potentially operative spacing distances 20213 is less than the maximum electrode spacing distance, which increases the risk of effecting an electrical discharge in an undesirable direction while a sufficient electrical potential difference is applied between a one of the at least one operative surface 220 of the first electrode structure 22 and the solid particulate matter layer 2021. For example, with respect to the undesirable direction, the undesirable direction is one where less than a predetermined desirable fraction of the gaseous reactant fluid flow 302 intersects the plasma plume 18 generated by the effected electric discharge while the plasma forming gaseous fluid 302 is disposed in the reaction zone 14. As a further example, and referring to FIG. 13, with respect to the undesirable direction, the undesirable direction is one where the axis 2321 of the inlet 232 is disposed at an acute angle XE of greater than 51 degrees relative to the longitudinal axis 1811 of the plasma plume 18 generated by the effected electric discharge while the plasma forming gaseous fluid 302 is disposed in the reaction zone 14. As a further example, with respect to the undesirable direction, the undesirable direction is one where the axis 2321 of the inlet 232 is disposed peripherally relative to the plasma plume 18 generated by the effected electric discharge while the plasma forming gaseous fluid 302 is disposed in the reaction zone 14.

For example, with respect to the internal structural surface 202, the internal structural surface 202 is a reaction vessel wall portion 2020. For example, the reaction vessel wall portion 2020 opposes the reaction zone 14. As a further example, the reaction vessel wall portion 2020 opposes the insulator 250. As a further example with respect to the internal structural surface 202, the internal structural surface is a portion of the insulator system 250. As a further example with respect to the internal structural surface 202, the internal structural surface 202 is a portion of the plasma generator disposed within the reaction vessel 12, such as the first electrode structure 22.

While the reactive process is being effected, particulate uncoupling gaseous fluid flow 306 is flowed for one of the following purposes: (i) mitigating coupling of solid particulate matter to an internal structural surface 202 with the reaction zone 14, or (ii) uncoupling solid particulate matter from an internal structural surface 202 disposed in fluid communication with the reaction zone 14, or for both of (i) and (ii). For example, the particulate uncoupling gaseous fluid flow 306 is flowed at a rate of 1.5 cubic metres per hour, and the plasma forming gaseous fluid flow (when it is the same as the reactant matter fluid flow) is flowed at a rate of 3.5 cubic metres per hour.

For example, the reaction vessel 12 includes the reaction vessel inlet 234 which introduces the particulate uncoupling gaseous fluid flow 306. For example, the inlet 234 introduces the particulate uncoupling gaseous fluid 306 tangentially relative to a wall surface portion 236 of the reaction compartment 141.

For example, the particulate uncoupling gaseous fluid flow 306 also functions as the stabilizing gaseous fluid flow. In this respect, for example, with respect to the introduction of the particulate uncoupling gaseous fluid through the inlet 234, the introduction of the particulate uncoupling gaseous fluid through the inlet 234 effects the vortical flow 3061 of the particulate uncoupling gaseous fluid such that the vortical flow 3061 of the particulate uncoupling gaseous fluid effects a spatial disposition of the plasma plume 18 such that at least a fraction of the gaseous reactant fluid flow 302 intersects the plasma plume 18. As a further example, with respect to the introduction of the particulate uncoupling gaseous fluid through the inlet 234, the introduction of the particulate uncoupling gaseous fluid through the inlet 234 effects the vortical flow 3061 of the particulate uncoupling gaseous fluid such that the vortical flow 3061 of the particulate uncoupling gaseous fluid effects a spatial disposition of the plasma plume 18 such that the axis 2321 of the inlet 232 intersects the plasma plume 18. As a further example, and referring to FIG. 10, with respect to the introduction of the particulate uncoupling gaseous fluid through the inlet 234, the plasma plume includes a longitudinal axis 1811, and the introduction of the particulate uncoupling gaseous fluid through the inlet 234 effects the vortical flow 3061 of the particulate uncoupling gaseous fluid such that the vortical flow 3061 of the particulate uncoupling gaseous fluid effects a spatial disposition of the plasma plume 18 such that the axis 2321 of the inlet 232 is disposed at an acute angle XA of less than 27 degrees relative to the axis 1811 of the plasma plume 18. For example, the axis 2321 is substantially co-located with the axis 1811. As a further example, with respect to the introduction of the particulate uncoupling gaseous fluid through the inlet 234, the introduction of the particulate uncoupling gaseous fluid through the inlet 234 effects a spatial disposition of the vortical flow 3061 of the particulate uncoupling gaseous fluid relative to the plasma plume 18 such that vortical flow 3061 is disposed substantially peripherally relative to the plasma plume 18.

For example, and referring to FIG. 10, with respect to the spatial disposition of the inlet 234, the inlet 234 includes an inlet axis 2341, and the inlet axis 2341 is transverse to the axis 2321 of the inlet 232. For example, the axis 2341 is disposed at an acute angle XB of less than 30 degrees relative to the axis 2321. For example, the axis 2341 is disposed at an acute angle XB of less than 15 degrees relative to the axis 2321. For example, the axis 2341 is substantially perpendicular relative to the axis 2321.

For example, and referring to FIG. 11, the outlet 222 includes an axis 2603. The axis 2341 is transverse to the axis 2603. For example, the axis 2341 is disposed at an acute angle XC of less than 30 degrees relative to the axis 2603. For example, the axis 2341 is disposed at an acute angle XC of less than 15 degrees relative to the axis 2603. For example, the axis 2341 is substantially perpendicular to the axis 2603. For example, the axis 2603 is substantially co-located with the axis 2321.

For example, with respect to the reaction compartment 141, the reaction compartment 141 includes a frusto-conical wall portion 2601 substantially extending from the outlet 222, and the outlet 222 includes the axis 2603.

For example, the reaction vessel 12 further includes an annular fluid passage 226 configured for effecting any of the above-described embodiments of the vortical flow 3061. The annular fluid passage 226 is disposed peripherally relative to the inlet 232. For example, the annular fluid passage is disposed radially relative to the inlet axis 2321. The inlet 234 discharges into the annular fluid passage 226. The annular fluid passage 226 receives the particulate uncoupling gaseous fluid introduced through the inlet 234 and includes an outlet 235 for effecting the discharge of the particulate uncoupling gaseous fluid into the reaction compartment 141 to effect the vortical flow 3061. For example, with respect to the effected vortical flow 3061, the effected vortical flow 3061 of the particulate uncoupling gaseous fluid effects a spatial disposition of the plasma plume 18 such that at least a fraction of the gaseous reactant fluid flow 302 intersects the plasma plume 18. As a further example, with respect to the effected vortical flow 3061, the effected vortical flow 3061 of the particulate uncoupling gaseous fluid effects a spatial disposition of the plasma plume 18 such that the axis 2321 of the inlet 232 intersects the plasma plume 18. As a further example, and referring to FIG. 10, with respect to the effected vortical flow 3061, the effected vortical flow 3061 of the particulate uncoupling gaseous fluid effects a spatial disposition of the plasma plume 18 such that the axis 2321 of the inlet 232 is disposed at an acute angle XA of less than 27 degrees relative to the axis 1811 of the plasma plume 18. For example, the axis 2321 is substantially co-located with the axis 1811. As a further example, with respect to the effected vortical flow 3061, the effected vortical flow 3061 is disposed substantially peripherally relative to the plasma plume 18.

For example, with respect to the annular fluid passage 226, the annular fluid passage 226 is defined between: (i) a sidewall 121 of the reaction vessel 12, the sidewall 121 including one or more of a plurality of potentially active surface portions 204 (described in further detail above), and (ii) the insulator 250 (the insulator 250 is described in further detail above, including its relationship with the first electrode structure 22 and the plurality of potentially active surface portions 206).

For example, with respect to the particulate uncoupling gaseous fluid flow 306, the particulate uncoupling gaseous fluid flow 306 includes substantially the same composition as the plasma-forming gaseous fluid and/or the reactant matter fluid.

E. Reactor System Aspect for Uncoupling of Solid Particulate Matter from INternal Structural Surface

Referring to FIGS. 1, 2, 3, and 4, in another aspect, there is provided a method of operating a reactor system 10 for uncoupling solid particulate matter from an internal structural surface 202 disposed within the reaction vessel 12 in fluid communication with the reaction zone 14. The reactor system 10 includes the reaction vessel 12 defining the reaction zone 14 and the plasma generator 16 for effecting a plasma discharge.

The method of operating a reactor includes an operating cycle which is repeated at least once, such that at least two executions of the operating cycle are provided. The operating cycle is defined by a first predetermined time interval and a second predetermined time interval. The second predetermined time interval commences upon completion of the first predetermined time interval. During the first predetermined time interval, generation of a plasma discharge is effected by the plasma generator 16, and reactant matter is contacted with the plasma discharge such that a reactive process is effected to produce product matter including solid particulate matter which becomes physically coupled to the internal structural surface 202. During the second predetermined time interval, particulate uncoupling gaseous fluid is flowed as a flow 308 and effects uncoupling of at least a fraction of the coupled solid particulate matter from the internal structural surface 202. Substantially no particulate uncoupling gaseous fluid is flowed as the flow 308 during the first predetermined time interval, and substantially no plasma discharge is effected during the second predetermined interval.

For example, with respect to the plasma generator 16, the plasma generator 16 includes: the current and voltage source 20, the first electrode structure 22, and the second electrode structure 24. The first electrode structure 22 is coupled to the reaction vessel 12, and includes at least one operative surface electrically connected to the current and voltage source 20. The second electrode structure 24 is physically coupled to the reaction vessel 12, and includes at least one operative surface. The second electrode structure 24 is spaced apart from the first electrode structure 22 and the reaction zone 14 is defined between the first and second electrode structures 22, 24. The plasma discharge is effected by the plasma generator 16 from a plasma forming gaseous fluid disposed within the reaction zone 14 while an electrical potential difference is applied between a one of the at least one operative surface of the first electrode structure 22 and a respective one of the at least one operative surface of the second electrode structure 24 by the current and voltage source 20 so as to effect an electrical discharge between the one of the at least one operative surface of the first electrode structure 22 and the respective one of the at least one operative surface of the second electrode structure 24 and through the reaction zone 14.

For example, with respect to the internal structural surface 202, the internal structural surface 202 is at least a fraction of the plasma generator 16, such as at least a fraction of the first electrode structure 22. As a further example with respect to the internal structural surface 202, the internal structural surface 202 is an internal wall surface 2020 of the reaction compartment 141 of the reaction vessel 12. For example, with respect to the internal wall surface 2020, the internal wall surface 2020 opposes the reaction zone 14.

For example, with respect to the application of the electrical potential difference between the first and second electrodes 22, 24, the application of the electrical potential difference is effected during the first predetermined time interval, and substantially no particulate uncoupling gaseous fluid is flowed as the flow 308 into the reaction vessel 12 during substantially the entire plasma generation time period. After the first predetermined time interval, the application of the electrical potential difference by the voltage and current source 20 between the first and second electrodes 22, 24 is at least temporarily terminated such that substantially no electrical potential difference is being applied by the voltage and current source 20 between the first and second electrodes 22, 24, and the second predetermined time interval is commenced. During the second predetermined time interval, substantially no electrical potential difference is being applied by the voltage and current source 20 between the first and second electrodes 22, 24, and the flowing of the particulate uncoupling gaseous fluid as the flow 308 into the reaction vessel 12 is effected so as to effect the uncoupling of the at least a fraction of the coupled solid particulate matter from the at least a fraction of the first electrode structure 22.

For example, with respect to each one of the executions of the operating cycle, for each one of the executions, the plasma discharge is substantially terminated prior to commencing the second predetermined time interval. As a further example with respect to each one of the executions, for each one of the executions, the flow 308 of the particulate uncoupling gaseous fluid 308 is substantially terminated prior to commencing the first predetermined time interval.

For example, with respect to the relative durations of the first and second predetermined time intervals, the duration of the first predetermined time interval of at least one of the at least two executions of the operating cycle is not equal to the duration of the first predetermined time interval of another one of the at least two executions of the operating cycle, and the duration of the second predetermined time interval of at least one of the at least two executions of the operating cycle is not equal to the duration of each one of at least another one of the at least two executions of the operating cycle.

For example, with respect to the duration of the first predetermined time interval, the duration of the first predetermined time interval is selected so that growth of a solid particulate matter mass 2027 on the first electrode structure 22, effected by coupling of the solid particulate matter to the first electrode structure 22, is limited such that the minimum electrode spacing distance does not decrease to an undesirable extent (from a “longer gap” to a “shorter gap”). This depends on the quality of product matter (for example, based on gaseous hydrogen concentration) being produced, and whether it is acceptable for downstream applications. As discussed above, during the plasma discharge, reactant matter is converted into product matter. The product matter includes solid particulate matter, including carbon particles. For example, the carbon particles become coupled to the surface of the tip of the first electrode structure 22. This accumulation process (sometimes referred to as:“carbon bridging” or “carbon bridge growing”) continues so long as plasma discharge is effected in the reaction zone 14 and reactant matter is introduced into the reaction zone (for example, the accumulated carbon is sometimes referred to as a “carbon bridge”). All or substantially all of the accumulated carbon remains coupled to the first electrode structure and does not decouple without the application of external forces to the accumulated carbon. The accumulated carbon effects the reduction in the gap between the first electrode structure 22 and the second electrode structure 24, and thereby reduces the volume of the reaction zone 14.

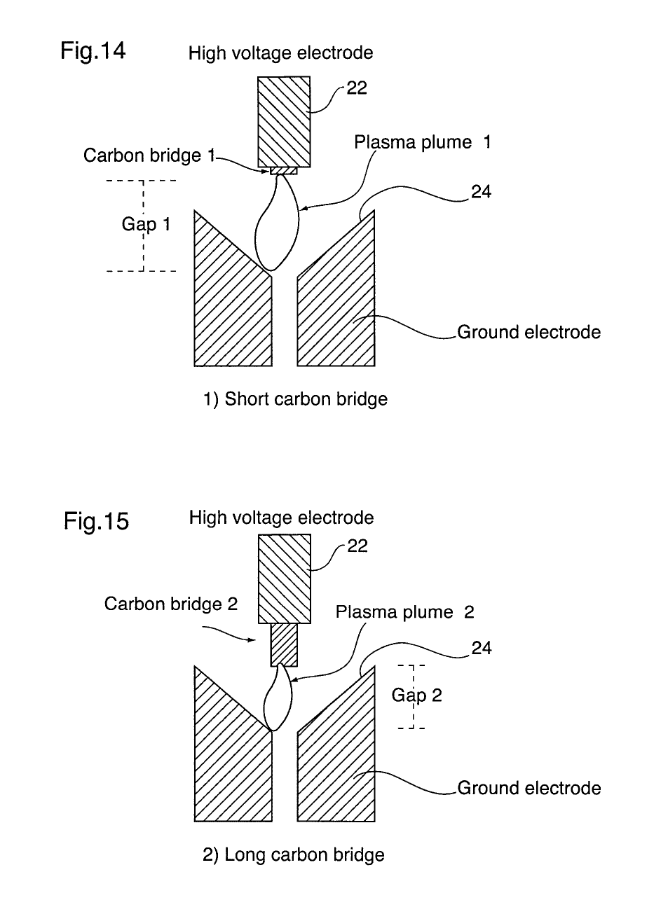

FIG. 14 illustrates a condition where the minimum spacing distance between the electrodes 22, 24 is of a first spacing distance (also referred to as the “short carbon bridge” condition), and FIG. 15 illustrates a condition where the minimum spacing distance between the electrodes 22, 24 is of a second spacing distance which is shorter than the first spacing distance (also referred to as the “long carbon bridge” condition). In the short carbon bridge condition, the plasma gap is “GAP 1”, the carbon bridge is “CARBON BRIDGE 1”, and the plasma plume is ‘PLASMA PLUME 1”. In the long carbon bridge condition, the plasma gap is “GAP 2”, the carbon bridge is “CARBON BRIDGE 2”, and the plasma plume is ‘PLASMA PLUME 2”. CARBON BRIDGE 1 is shorter than CARBON BRIDGE 2. GAP 1 is longer than GAP 2. PLASMA PLUME 1 is longer than PLASMA PLUME 2.

In comparison to the shorter gap condition, under the longer gap condition, a larger plasma plume is effected in the reaction zone, thereby increasing the efficiency of conversion of reactant matter (being introduced into the reaction zone 14) into product matter. As well, in comparison to the shorter gap condition, under the longer gap condition, more power input to the reaction zone is effected and this, combined with providing a larger plasma plume in the reaction zone effects production of product matter including a higher concentration of gaseous hydrogen.

For example, with further respect to the duration of the first predetermined time interval, the duration of the first predetermined time interval is also selected to mitigate against the generation of the plasma plume 18 in an undesirable location. Physical coupling of the solid particulate matter to the internal structural surface 202 during the above-described reactive process effects the formation of a solid particulate matter layer 2021 on the internal structural surface 202. The solid particulate matter layer 2021 includes a plurality of potentially active solid particulate matter layer surface portions 20211. Each one of the plurality of potentially active solid particulate matter surface portions 20211 is spaced apart from each one of the at least one operative surface 220 of the first electrode structure 220 by a respective linear distance which is a respective potentially operative spacing distance 20213, such that a plurality of respective potentially operative spacing distances 20213 are provided. As the reactive process continues, the physical coupling of the solid particulate matter to the internal structural surface 202 also continues (through association of new solid particulate matter with the solid particulate matter already adhered to the internal structural surface 202, as described above), effecting accumulation of the coupled solid particulate matter and the growth of the solid particulate matter layer 2021. As the solid particulate matter layer 2021 grows, there is a risk that at least one of the plurality of respective potentially operative spacing distances 20213 is less than the maximum electrode spacing distance, which increases the risk of effecting an electrical discharge in an undesirable direction while a sufficient electrical potential difference is applied between a one of the at least one operative surface 220 of the first electrode structure 22 and the solid particulate matter layer 2021. For example, and referring to FIG. 10 with respect to the undesirable direction, the undesirable direction is one where the axis 2321 of the inlet 232 is disposed at an acute angle XA of greater than 27 degrees relative to the longitudinal axis 1811 of the plasma plume 18 generated by the effected electric discharge while the plasma forming gaseous fluid 302 is disposed in the reaction zone 14. As a further example, with respect to the undesirable direction, the undesirable direction is one where the axis 2321 of the inlet 232 is disposed peripherally relative to the plasma plume 18 generated by the effected electric discharge while the plasma forming gaseous fluid 302 is disposed in the reaction zone 14.

For example, with respect to the duration of the first predetermined time interval, the duration of the first predetermined time interval is not so long such that the mass 2027 or the layer 2021 grows to an unacceptable degree. As well, the duration is not so long as to facilitate electrode erosion.

For example, with respect to the duration of the second predetermined time interval, the duration of the second predetermined time interval is not so long as to effect unacceptable variation in the material composition of product matter, but is sufficiently long so as to effect sufficient decoupling of the solid particulate matter from the internal structural surface 202.

For example, with respect to the durations of the first predetermined time intervals, the duration of the first predetermined time interval is between 15 seconds and 300 seconds. As a further example, the duration of the first predetermined time interval is between 30 seconds and 120 seconds. As a further example, the duration of the first predetermined time interval is 30 seconds. For example, with respect to the duration of the second predetermined time interval, the duration of the second predetermined time interval is between 0.02 seconds and 0.05 seconds. As a further example, the duration of the second predetermined time interval is between 0.02 seconds and 0.1 seconds. As a further example, the duration of the second predetermined time interval is 0.05 seconds. It is understood that the first predetermined time interval for each one of the executions of the operating cycle is not necessarily of the same time duration. As well, it is understood that the second predetermined time interval for each one of the executions of the operating cycle is not necessarily of the same time duration.

For example, with respect to the particulate uncoupling gaseous fluid flow 308, the particulate uncoupling gaseous fluid flow 308 is a burst of particulate uncoupling gaseous fluid (i.e. a “gas burst”).

For example, with further respect to the particulate uncoupling gaseous fluid flow 308, the particulate uncoupling gaseous fluid of the particulate uncoupling gaseous fluid flow 308 has substantially the same composition as the plasma forming gaseous fluid 304. As a further example of the particulate uncoupling gaseous fluid, the particulate uncoupling gaseous fluid is an inert gas such as nitrogen or argon. As a further example of the particulate uncoupling gaseous fluid, the particulate uncoupling gaseous fluid is essentially hydrogen gas or essentially a mixture of hydrogen gas and methane.

As a further example of the particulate uncoupling gaseous fluid flow 308, the particulate uncoupling gaseous fluid flow 308 is flowed into the reaction vessel 12 through the inlet 280, and the pressure of the particulate uncoupling gaseous fluid flow 308 as the particulate uncoupling gaseous fluid flow 308 enters the reaction vessel 12 from the inlet 280 is at least about 100 psi, and the pressure within the reaction zone is about atmospheric. For example, the pressure within the reaction zone is less than 2 atmospheres. For example, this inlet pressure of the gaseous fluid flow 308 is from 100 psi to 150 psi. For example, the pressure gradient between the inlet 280 and the reaction zone is between 100 psi and 150 psi. For example, a suitable gas velocity of the burst gas at or near the point of impact with the coupled solid particulate matter (for example, the “carbon bridge” coupled to the first electrode structure 22) is between 630 metres per second and 890 metres per second.

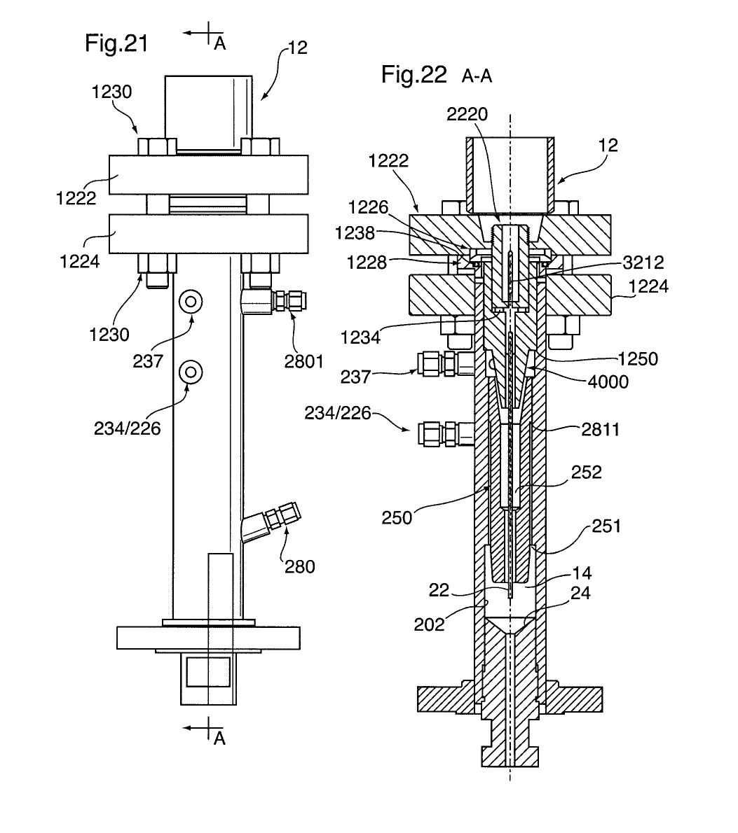

Referring to FIGS. 21 and 22, in another embodiment, the reaction vessel 14 includes two inlets 280, 2801 for introducing fluid flow 308 into the vessel. Additional inlet 2801 is provided to introduce flow 308 through the fluid passage 228.

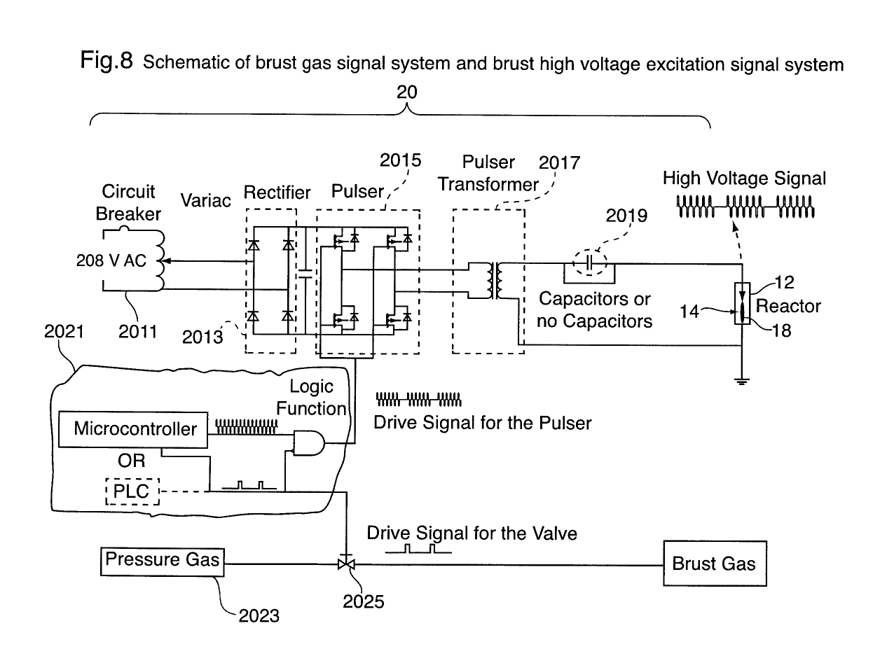

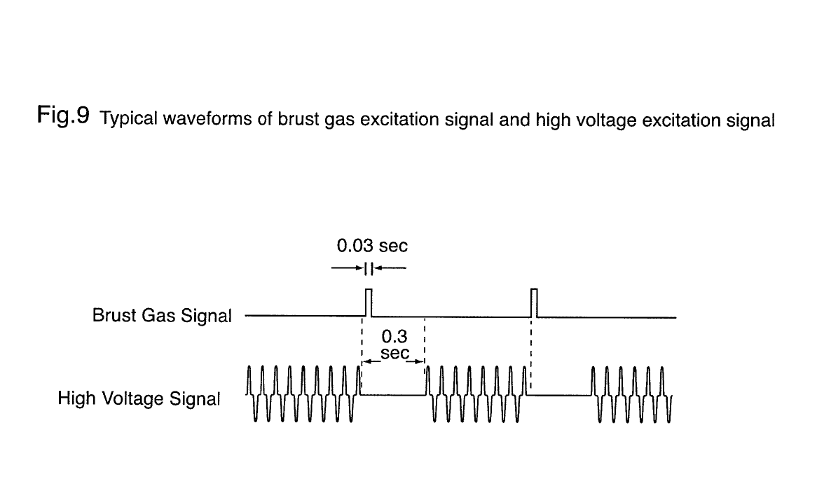

FIG. 8 is a schematic illustration of an embodiment of an electric circuit for effecting a co-ordinated operating cycle for the reactor system 10. High voltage power is effected to the reactor system 10 from the current and voltage source 20 for a first predetermined time interval in response to a transmitted high voltage excitation signal from a controller 2021. Particulate uncoupling gaseous fluid flow 308 is effected for a subsequent second predetermined time interval in response to a burst gas excitation signal transmittal from the controller 2021 to a valve 2025 which controls the particulate uncoupling gaseous fluid flow 308 (or “burst gas”) from the gas supply 2023. FIG. 9 illustrates typical waveforms for the high voltage excitation signal and the burst gas excitation signal. Waveforms for two completed executions of the operating cycle are illustrated. The high voltage excitation signal is transmitted for a first predetermined time interval, thereby effecting generation of the plasma discharge by the plasma generator. Upon completion of the first predetermined time interval, the high voltage excitation signal is terminated, thereby substantially terminating the generation of the plasma discharge. Further, upon completion of the first predetermined time interval, the transmission of thee burst gas excitation signal is commenced and continues for a second predetermined time interval. In the example illustrated, the second predetermined time interval is 0.3 seconds. Transmission of the burst gas excitation signal effects opening of the valve 2025 thereby effecting the flow 308 of particulate uncoupling gaseous fluid from the gas supply 2023 to the reaction vessel 308 through inlet 280. While the burst gas excitation signal is transmitted to the valve 2025, the valve 2025 remains open and the flow 308 is effected to the reaction vessel 308 through the inlet 280. Termination of the transmission of the burst gas excitation signal effects closing of the valve 2025, thereby effecting termination of the flow 308.

There is also provided a method of operating a reactor system 10 including operating the reactor system 10 in an experimental mode, measuring the rate of physical coupling of the solid particulate matter, and then operating the reactor system 10 in a normal operating mode, wherein the normal operating mode is designed to mitigate against deleterious operation of the reactor system 10 caused by the physical coupling of the solid particulate matter, and the design of the normal operating mode is based on the measured rate of physical coupling of the solid particulate matter during the experimental mode.

The operating of the reactor system 10 in an experimental mode includes generating a test plasma discharge by the plasma generator 16, contacting the test plasma discharge with test reactant matter, such that a reactive process is effected to produce test product matter including test solid particulate matter which becomes physically coupled to at least a fraction of the plasma generator, and measuring the rate of physical coupling of the solid particulate matter.

The operation of the reactor system 10 in a normal operating mode includes an operating cycle. The operating cycle is defined by a first predetermined time interval and a second predetermined time interval. The second predetermined time interval commences substantially after completion of the first predetermined time interval. The duration of the first predetermined time interval is based upon the measured rate of physical coupling of the solid particulate matter to the internal structural surface 202 during the experimental mode For example, with respect to the duration of the first predetermined time interval, the duration of the first predetermined time interval is selected so that growth of a solid particulate matter mass 2027 on the first electrode structure 22 is limited such that the minimum electrode spacing distance does not decrease to such an extent that the space defining the reaction zone becomes unacceptably small and to such an extent that the power input to the reaction zone is decreased and thereby resulting in undesirable changes to the composition of the product matter.

In some embodiments, physical coupling of the solid particulate matter to the internal structural surface 202 during the above-described reactive process effects the formation of a solid particulate matter layer 2021 on the internal structural surface 202. The solid particulate matter layer 2021 includes a plurality of potentially active solid particulate matter layer surface portions 20211. Each one of the plurality of potentially active solid particulate matter surface portions 20211 is spaced apart from each one of the at least one operative surface 220 of the first electrode structure 220 by a respective linear distance which is a respective potentially operative spacing distance 20213, such that a plurality of respective potentially operative spacing distances 20213 are provided. As the reactive process continues, the physical coupling of the solid particulate matter to the internal structural surface 202 also continues (through association of new solid particulate matter with the solid particulate matter already adhered to the internal structural surface 202, as described above), effecting accumulation of the coupled solid particulate matter and the growth of the solid particulate matter layer 2021. As the solid particulate matter layer 2021 grows, there is a risk that at least one of the plurality of respective potentially operative spacing distances 20213 is less than the maximum electrode spacing distance, which increases the risk of effecting an electrical discharge in an undesirable direction while a sufficient electrical potential difference is applied between a one of the at least one operative surface 220 of the first electrode structure 22 and the solid particulate matter layer 2021. For example, and referring to FIG. 10, with respect to the undesirable direction, the undesirable direction is one where the axis 2321 of the inlet 232 is disposed at an acute angle XA of greater than 27 degrees relative to the longitudinal axis 1811 of the plasma plume 18 generated by the effected electric discharge while the plasma forming gaseous fluid 302 is disposed in the reaction zone 14. As a further example, with respect to the undesirable direction, the undesirable direction is one where the axis 2321 of the inlet 232 is disposed peripherally relative to the plasma plume 18 generated by the effected electric discharge while the plasma forming gaseous fluid 302 is disposed in the reaction zone 14.

During the first predetermined time interval, generation of a normal operation plasma discharge is effected by the plasma generator 16, and normal operation reactant matter is contacted with the normal operation plasma discharge such that a reactive process is effected to produce normal operation product matter including normal operation solid particulate matter which become physically coupled to at least a fraction of the plasma generator 16. During the second time interval, the particulate uncoupling gaseous fluid is flowed as the flow 308 and effects uncoupling of at least a fraction of the coupled solid particulate matter. Substantially no particulate uncoupling gaseous fluid is flowed as the flow 308 during the first predetermined time interval, and substantially no plasma discharge is effected during the second predetermined time interval.

For example, each one of the normal operation reactant matter, the normal operation plasma discharge, the normal operation product matter, and the normal operation solid particulate matter has substantially the same composition as a corresponding one of the test reactant matter, the test plasma discharge, the test product matter, and the test solid particulate matter.

For example, with respect to the operating cycle, the operating cycle is repeated at least once such that at least two executions of the operating cycle are provided, and wherein the duration of the first predetermined time interval of each one of the executions is based upon the measure rate of physical coupling of the solid particulate matter during the experimental mode.

### F. Reactor System Aspect for Facilitating Positioning of Second Electrode

Referring to FIGS. 1, 2, 3, and 4, in another aspect, for the reactor system 10 including the plasma generator 16, wherein the plasma generator 16 includes the current and voltage source 20, the first electrode structure 22, and the second electrode structure 24, the reactor system 10 is configured for facilitating positioning of the second electrode structure 24.

The second electrode structure 24 is adjustably positionable relative to the first electrode structure 22. In this respect, for example, the reaction vessel 12 includes an internal surface, and the internal surface includes a seating surface 292. The second electrode structure 24 is supported by the seating surface. The second electrode structure 24 is positionable to assume closer proximity to the first electrode structure 22 by inserting one or more spacers between the second electrode structure 24 and the seating surface 292.

For example, with respect to the spacers 294, each one of the spacers 294 is electrically conductive and operates robustly in high temperature conditions. For example, the material of each one of the spacers 294 is stainless steel. As a further example with respect to the spacers 294, where the second electrode structure 24 includes the aperture 241 for discharging product matter to the outlet 224 from the reaction zone 14, each one of the spacers 294 includes a centrally disposed aperture 296, such that each one of the spacers 294 does not substantially interfere with discharging of product matter through the outlet 224. In this respect, for example, each one of the spaces 294 is in the form of a substantially flat washer. For example, the thickness of each one of the spacers 294 is about 0.05 inches or thinner. The outside diameter of each one of the spacers 294 is substantially the same as the maximum outside diameter of the second electrode structure, and the inside diameter is about 0.01 inches larger than the maximum diameter of the aperture 241 of the second electrode structure 24 (the aperture 241 is provided to facilitate flow of product from the reaction zone 14 and to the outlet 222).

There is also provided a method of operating a reactor system 10. The reactor system 10 includes a reaction vessel 12 and a plasma generator 16. The reaction vessel 12 defines a reaction zone 14, and also including the internal surface 290 including the seating surface 292. Plasma is generated in the reaction zone 14 with a plasma generator 16. The plasma generator 16 includes a current and voltage source 20, a first electrode structure 22, and a second electrode structure 24. The first electrode structure 22 is physically coupled to the reactor system 10. The first electrode structure 22 includes at least one operative surface 220 electrically coupled to the current and voltage source 20 for effecting an electrical discharge. The second electrode structure 24 is supported on the seating surface 292, and includes at least one operative surface 240 configured for receiving the electrical discharge. The second electrode structure 24 is spaced apart from the first electrode structure 22, and the reaction zone 14 is defined between the first and second electrode structures 22, 24.

As the plasma is generated by the plasma generator, the second electrode structure 24 becomes eroded, such that the spacing between the first and second electrodes increases as the plasma is generated by the plasma generator 16. After the spacing between the first and second electrode structures 22, 24 has increased by a predetermined amount from an initial spacing, at least one spacer 292 is inserted between the second electrode structure 24 and the seating surface 290, such that the second electrode structure 24 becomes disposed in closer proximity to the first electrode structure 22.

Erosion occurs due to surface heating of the electrode and subsequent combination of electron bombardment, stimulated sputtering, and evaporation losses of metal. Spattering and evaporation of the electrode are known as two main erosion mechanisms. Ions impinging on the metal surface of the electrode can sputter metallic atoms, and strong local heating and formation of hot spots on the electrode can cause electrode evaporation.

To facilitate adjustable positioning of the second electrode 24, the reaction vessel 12 includes a first section 400 and a second section 402, wherein the second section 402 is releasably coupled to the first section 400 and includes the second electrode structure 24. For example, the first section 400 is releasably coupled to the second section 402 with a plurality of bolts. Alternatively, the releasable coupling is by way of clamps. The second section 402 is configured such that, when the first section 400 is uncoupled from the second section 402, manual repositioning of the second electrode structure 24 is configured to occur substantially unobstructed.

### G. Reactor System Aspect for Facilitating Replacement of Electrode

Referring to FIGS. 1, 2, 3, and 4, in another aspect, for the reactor system 10 including the plasma generator 16, wherein the plasma generator 16 includes the current and voltage source 20, the first electrode structure 22, and the second electrode structure 24, the reactor system 10 is configured for facilitating removal of coupled solid particulate matter which is coupled to the second electrode 24.

In this respect, the reaction vessel 12 includes the internal wall portion 290 defining the seating surface 292. The second electrode structure 24 rests upon and is supported by the seating surface 292 of the internal wall portion 290 of the reaction compartment 141 of the reaction vessel 12.

For example, when supported by the seating surface 292, the second electrode structure 24 is spaced apart from an opposing and adjacent wall surface of the reaction vessel by a gap. For example, the minimum distance of the gap is about 0.01 inches. This gap is provided to facilitate removal of the second electrode structure 24.

As the plasma is generated by the plasma generator 16, the second electrode structure 24 becomes eroded. Eventually, the second electrode structure 24 becomes eroded to an undesirable degree such that the second electrode structure 24 must be replaced.

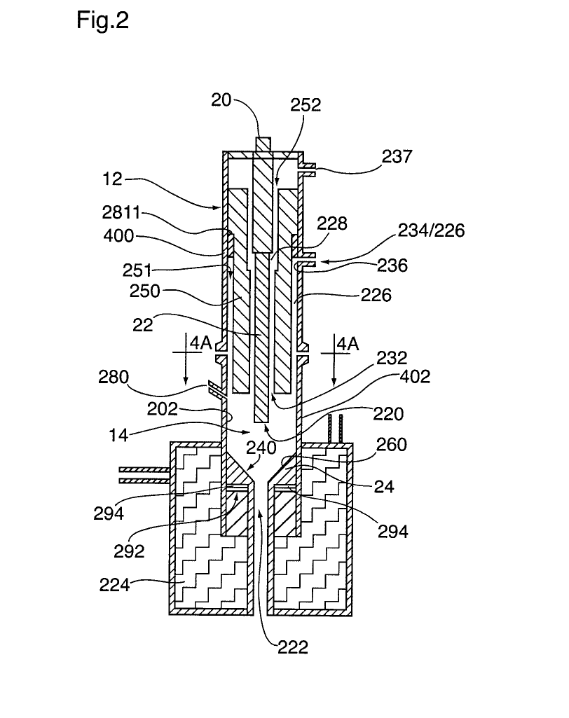

Referring to FIG. 2, to facilitate replacement of the second electrode structure 24, the reaction vessel 12 includes the first section 400 and the second section 402, wherein the second section 402 is releasably coupled to the first section 400 and includes the second electrode structure 24. For example, the first section 400 is releasably coupled to the second section 402 with mechanical fasteners, such as a plurality of bolts. The second section 402 is configured such that, when the first section 400 is uncoupled from the second section 402, manual removal of an eroded second electrode structure 24 is configured to occur substantially unobstructed.

There is also provided a method of operating a reactor system 10. The reactor system 10 includes the reaction vessel 12 defining the reaction zone 14 and including the first section 400 releasably coupled to the second section 402. The second section 402 includes the internal wall portion defining the seating surface 292. The reactor system 10 also includes the plasma generator 16 including the current and voltage source 20, the first electrode structure 22, and the second electrode structure 24. The second electrode structure 24 rests upon and is supported by the seating surface 292. The second section 402 is configured such that, when the first section 400 is uncoupled from the second section 402, manual removal of an eroded second electrode structure 24 is configured to occur substantially unobstructed.

The method includes flowing a plasma forming gaseous fluid to the reaction zone 14 of the reaction vessel 12 and generating a plasma in the reaction zone 14 with the plasma generator 16, such that generation of the plasma in the reaction zone 14 effects erosion of the second electrode 24. Upon determining that the second electrode 24 has become eroded by a predetermined amount and during a time period when the plasma forming gaseous fluid is not flowing to the reaction zone and when the current and voltage source 20 is not applying an electric potential difference between the first and second electrode structures 22, 24, uncoupling the first section 400 from the second section 402, removing the eroded second electrode structure 24 from the seating surface 292, and replacing the eroded second electrode structure 24 with a suitable replacement second electrode structure 24. For example, determination of the fact that the several electrode 24 has become eroded by a predetermined amount is effected through visual inspection of periodic inspections.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

### Appendix “A”—Reactions

The dominant reactions that initiate the process are:

e + CH₄ => CH₄* + e
e + CH₄ => CH₃ + H + e
e + CH₄ => CH₂ + H₂ + e
e + CH₄ => CH + H₂ + H + e
e + CH4 => CH3 + H* + e

Other reactions include:

| | Reaction |
|---|---|
| | I. Electron-impact reactions of methane and hydrocarbons |
| 1 | e + CH₄ => CH₄ + e |
| 2 | e + CH₄ => CH₄ + e |
| 3 | e + CH₄ => CH₄ + e |
| 4 | e + CH₄ => CH₄* + e |
| 5 | e + CH₄ => CH₃ + H + e |
| 6 | e + CH₄ => CH₂ + H₂ + e |
| 7 | e + CH₄ => CH + H₂ + H + e |
| 8 | e + C₂H₆ => C₂H₆ + e |
| 9 | e + C₂H₆ => C₂H₆ + e |
| 10 | e + C₂H₆ => C₂H₅ + H + e |
| 11 | e + C₂H₆ => C₂H₄ + H₂ + e |
| 12 | e + C₂H₄ => C₂H₂ + H + H + e |
| 13 | e + C₂H₄ => C₂H₄ + e |
| 14 | e + C₂H₄ => C₂H₄ + e |
| 15 | e + C₂H₄ => C₂H₄ + e |
| 16 | e + C₂H₂ => C₂H₂ + e |
| 17 | e + C₂H₂ => C₂H₂ + e |
| 18 | e + C₃H₈ => C₂H₄ + CH₄ + e |
| 19 | e + C₄Hₓ => C₃Hₓ + CH₄ + e |
| 20 | e + CH₄ => CH₃ + H* + e |
| 21 | e + CH₄ => CH₂ + H + H* + e |
| 22 | e + CH₄ => CH* + H₂ + H + e |
| 23 | e + CH₄ => CH₄⁺ + 2e |
| 24 | e + CH₄ => CH₃⁺ + H + 2e |
| 25 | e + CH₄ => CH₂⁺ + H₂ + 2e |
| 26 | e + CH₄ => CH⁺ + H₂ + H* + 2e |
| 27 | e + CH₄ => C⁺ + 4H* + 2e |
| 28 | e + C₂H₄ => C₂H₄⁺ + 2e |
| 29 | e + C₂H₆ => C₂H₄⁺ + H₂ + 2e |
| 30 | e + C₂H₂ => C₂H₂⁺ + 2e |
| 31 | e + C₃H₈ => C₂H₅⁺ + CH₃ + 2e |
| 32 | e + C₄Hₓ => C₃Hₓ⁺ + CH₃ + 2e |
| | Electron-impact reactions of Hydrogen |
| 33 | e + H₂ => H₂ + e |
| 34 | e + H₂ => H₂ + e |
| 35 | e + H₂ => H₂ + e |
| 36 | e + H₂ => H + H + e |
| 37 | e + H₂ => H₂⁺ + 2e |
| 38 | e + H => H + e |
| 39 | e + H => H⁺ + 2e |
| | II. Ion-Molecule Reaction |
| 40 | C⁺ + CH₄ => C₂H₂⁺ + H₂ |
| 41 | C⁺ + CH₄ => C₂H₃⁺ + H |
| 42 | CH⁺ + CH₄ => C₂H₂⁺ + H₂ + H |
| 43 | CH⁺ + CH₄ => C₂H₃⁺ + H₂ |
| 44 | CH⁺ + CH₄ => C₂H₄⁺ + H |
| 45 | CH⁺ + H₂ => CH₂⁺ + H |
| 46 | CH₂⁺ + CH₄ => C₂H₄⁺ + H₂ |
| 47 | CH₂⁺ + CH₄ => C₂H₅⁺ + H |
| 48 | CH₂⁺ + H₂ => CH₃⁺ + H |
| 49 | CH₂⁺ + CH₄ => CH₃⁺ + CH₃ |
| 50 | CH₂⁺ + CH₄ => C₂H₂⁺ + 2H₂ |
| 51 | CH₂⁺ + CH₄ => C₂H₃⁺ + H + H₂ |
| 52 | CH₃⁺ + CH₄ => CH₄⁺ + CH₃ |
| 53 | CH₃⁺ + CH₄ => C₂H₅⁺ + H₂ |
| 54 | CH₄⁺ + CH₄ => CH₅⁺ + CH₃ |
| 55 | CH₄⁺ + H₂ => CH₅⁺ + H |
| 56 | CH₅⁺ + C₂H₆ => C₂H₅⁺ + H₂ + CH₄ |
| 57 | C₂H₂⁺ + CH₄ => C₃H₄⁺ + H₂ |
| 58 | C₂H₂⁺ + CH₄ => C₂H₃⁺ + CH₃ |
| 59 | C₂H₂⁺ + CH₄ => C₃H₅⁺ + H |
| 60 | C₂H₃⁺ + CH₄ => C₃H₅⁺ + H₂ |
| 61 | C₂H₃⁺ + C₂H₄ => C₂H₅⁺ + C₂H₂ |
| 62 | C₂H₃⁺ + C₂H₂ => C₄H₅⁺ |
| 63 | C₂H₄⁺ + C₂H₄ => C₃H₅⁺ + CH₃ |
| 64 | C₂H₄⁺ + C₂H₄ => C₄H₈⁺ |
| 65 | C₂H₄⁺ + C₂H₆ => C₃H₆⁺ + CH₄ |
| 66 | C₂H₄⁺ + C₂H₆ => C₃H₇⁺ + CH₃ |
| 67 | C₂H₅⁺ + C₂H₄ => C₃H₅⁺ + CH₄ |
| 68 | C₂H₅⁺ + C₂H₃ => C₄H₈⁺ |
| 69 | H₂⁺ + H₂ => H₃⁺ + H |
| 70 | H₃⁺ + CH₄ => CH₅⁺ + H₂ |
| 71 | H₃⁺ + C₂H₂ => C₂H₃⁺ + H₂ |
| 72 | H₃⁺ + C₂H₄ => C₂H₅⁺ + H₂ |
| | III. Neutral - Neutral Reactions |
| 73 | CH₃ + CH₃ = C₂H₆ |
| 74 | CH3 + CH3 = C₂H₄ + H2 |
| 75 | CH3 + H = CH4 |
| 76 | CH3 + CH2 = C₂H₄ + H |
| 77 | CH3 + H2 = CH4 + H |
| 78 | CH3 + CH3 = C₂H₅ + H |
| 79 | CH3 + C2H6 = CH4 + C2H5 |
| 80 | CH + CH₄ = C₂H₅ |
| 81 | CH + C₂H₄ = C₃H₅ |
| 82 | CH + C₂H₆ = C₃H₇ |
| 83 | CH + C₃H₇ = C₄H₈ |
| 84 | CH + C2H2 = C3H2 + H |
| 85 | CH₂ + H₂ = CH₃ + H |
| 86 | CH2 + H = CH + H2 |
| 87 | CH2 + CH4 = CH3 + CH3 |
| 88 | CH2 + C2H6 = CH3 + C2H5 |
| 89 | CH2 + C2H5 = C2H4 + CH3 |
| 90 | CH2 + C2H5 = C3H6 + H |
| 91 | CH2 + C2H4 = C3H6 |
| 92 | CH2 + C2H3 = C2H2 + CH3 |
| 93 | CH2 + C2H2 = C3H4 |
| 94 | CH2 + C2H2 = C3H3 + H |
| 95 | CH2 + C2H = C2H2 + CH |
| 96 | CH₂ + CH₂ = C₂H₂ + H₂ |
| 97 | CH₂ + CH₂ = C₂H₂ + H + H |
| 98 | CH₂ + CH₂ = CH₃ + CH |
| 99 | CH₄ + CH₂ = C₂H₆ |
| 100 | CH₄ + H = CH₃ + H₂ |
| 101 | C₂H₆ + H = C₂H₅ + H₂ |
| 102 | C₂H₅ + H₂ = C₂H₆ + H |
| 103 | C₂H₅ + H = C₂H₆ |
| 104 | C₂H₅ + H = CH₃ + CH₃ |
| 105 | C₂H₅ + H = C₂H₄ + H₂ |
| 106 | C₂H₅ + CH₃ = C₃H₈ |
| 107 | C₂H₅ + CH₃ = CH₄ + C₂H₄ |
| 108 | C₂H₅ + C₂H₅ = C₂H₄ + C₂H₆ |
| 109 | C₂H₅ + C₂H₅ = C₄H₁₀ |
| 110 | C₂H₅ + CH₄ = C₂H₆ + CH₃ |
| 111 | H + C₂H₅ (+M) = C₂H₆ (+M) |
| 112 | C₂H₄ + H2 = C₂H₅ + H |
| 113 | C₂H₄ + H = C₂H₅ |
| 114 | C₂H₄ + H = C₂H₃ + H2 |
| 115 | C₂H₄ + CH₃ = C₂H₃ + CH4 |
| 116 | C₂H₄ + M = C₂H₂ + H2 + M |
| 117 | C₂H₄ + M = C₂H₃ + H + M |
| 118 | C₂H₄ + CH₃ = C₃H₇ |
| 119 | C₂H₄ + C₂H₅ = C₂H₆ + C₂H₃ |
| 120 | C₂H₄ + C₂H₄ = C₂H₃ + C₂H₅ |
| 121 | C₂H₃ + CH3 = C₂H₂ + CH4 |
| 122 | C₂H₃ + H = C₂H₂ + H₂ |
| 123 | C₂H₃ + CH₄ = C₂H₄ + CH₃ |
| 124 | C₂H₃ + CH₃ = C₂H₂ + CH₄ |
| 125 | C₂H₃ + CH₃ = C₃H₆ |
| 126 | C₂H₃ + CH₃ = C₃H₅ + H |
| 127 | C₂H₃ + C2H5 = C₄H₈ |
| 128 | C₂H₃ + C2H5 = C₃H₅ + CH3 |
| 129 | C₂H₃ + C2H5 = C₂H₄ + C₂H₄ |
| 130 | C₂H₃ + C₂H₅ = C₂H₂ + C₂H₆ |
| 131 | C₂H₃ + C₂H₄ = C₄H₆ + H |
| 132 | C₂H₃ + C₂H₃ = C₄H₆ |
| 133 | C₂H₃ + C₂H₃ = C₂H₄ + C₂H₂ |
| 134 | C₂H₃ + C₂H₃ = C₄H₅ + H |
| 135 | C₂H₂ + H2 = C₂H₄ |
| 136 | C₂H₂ + H2 = C₂H₃ + H |
| 137 | C₂H₂ + CH3 = C₃H₅ |
| 138 | C2H2 + CH3 = CH4 + C2H |
| 139 | C2H2 + C2H5 = C2H + C2H6 |
| 140 | C2H2 + C2H2 = C2H3 + C2H |
| 141 | C2H2 + C2H3 = C4H4 + H |
| 142 | C2H2 + M = C2 + H2 + M |
| 143 | C2H + H2 = C2H2 + H |
| 144 | C2H + H = C2H2 |
| 145 | C2H + CH4 = C2H2 + CH3 |
| 146 | C2H + C2H6 = C2H2 + C2H5 |
| 147 | C2H + CH3 = C3H3 + H |
| 148 | C2H + C2H5 = C2H2 + C2H4 |
| 149 | C2H + C2H5 = C3H3 + CH3 |
| 150 | C2H + C2H4 = C4H4 + H |
| 151 | C2H + C2H3 = C4H4 |
| 152 | C2H + C2H3 = C4H3 + H |
| 153 | C2H + C2H3 = C2H2 + C2H2 |
| 154 | C2H + C2H2 = C4H2 + H |
| 155 | C2H + C2H = C4H2 |
| 156 | C2H + C2H = C2H2 + C2 |
| 157 | C2H + C2H2(+M) = C4H3 (+M) |
| 158 | H + H = H2 |
| 159 | H + H (+M) = H2 (+M) |
| 160 | H + H + H2 = H2 + H2 |
| 161 | 2CH₃ (+M) = C₂H₆ (+M) |
| 162 | H + C₂H₄ (+M) = C₂H₅ (+M) |
| 163 | CH₃ + CH₃ = C₂H₅ + H |
| 164 | C3H2 + CH = C4H2 + H |
| 165 | C3H2 + CH2 = C4H3 + H |
| 166 | C3H2 + CH3 = C4H4 + H |
| 167 | C3H2 + CH3(+M) = C4H6 (+M) |
| 168 | C3H3 + CH = C4H3 + H |
| 169 | C3H2 + CH2 = C4H4 |
| 170 | C3H3 + CH2 = C4H4 + H |
| 171 | C3H2 + H = C3H3 |
| 172 | C3H3 + H + M = C3H4 + M |
| 173 | C3H4 + H = C3H3 + H2 |
| 174 | C3H4 + H = CH3 + C2H2 |
| 175 | C3H4 + CH2 = C4H6 |
| 176 | C3H6 + H = CH3 + C2H4 |
| 177 | C3H6 + H = C3H7 |
| 178 | C3H8 + H = C3H7 + H2 |
| 179 | C3H8 + C₂H₅ = C3H7 + C₂H₆ |
| 180 | C3H8 + CH3 = C3H7 + CH4 |
| 181 | C3H8 + C₂H₃ = C3H7 + C₂H₄ |
| 182 | C3H8 + C2H = C3H7 + C2H2 |
| 183 | C3H8 + CH2 = C4H10 |
| 184 | C3H7 + H2 = C3H8 + H |
| 185 | C3H7 + H = C3H6 + H2 |
| 186 | C3H7 + H = C3H8 |
| 187 | C3H7 + CH4 = C3H8 + CH3 |
| 188 | C3H7 + CH3 = CH4 + C3H6 |
| 189 | C3H7 + CH3 = C4H10 |
| 190 | C3H7 + C2H5 = C3H6 + C₂H₆ |
| 191 | C3H7 + C2H5 = C3H8 + C₂H₄ |
| 192 | C3H7 + C2H5 = C5H12 |
| 193 | C3H7 + C2H3 = C₂H₄ + C3H6 |
| 194 | C3H7 + C2H3 = C3H8 + C₂H₂ |
| 195 | C3H7 + C2H3 = C5H10 |
| 196 | C3H7 + C2H2 = C3H5 + C₂H₄ |
| 197 | C3H7 + C2H = C2H2 + C3H6 |
| 198 | C3H7 + C2H = C3H3 + C2H5 |
| 199 | C3H7 + CH2 = C2H4 + C2H5 |
| 200 | C3H7 + CH2 = C3H6 + CH3 |
| 201 | C3H7 + C3H7 = C6H14 |
| 202 | C4H6 + H = C4H5 + H2 |
| 203 | C4H5 + H = C4H4 + H2 |
| 204 | C4H5 + H = C3H3 + CH3 |
| 205 | C4H4 + H = C4H3 + H2 |
| 206 | C4H3 + H = C4H2 + H2 |
| 207 | C4H6 = C4H5 + H |
| 208 | C4H4 + C2H = C4H3 + C2H2 |
| 209 | C4H4 + C2H3 = C2H4 + C4H3 |
| 210 | C4H4 + C2H = C4H2 + C2H3 |
| 211 | C4H4 + C2H2 = C6H5 + H |
| 212 | C4H8 = CH3 + C3H5 |
| 213 | C4H8 = C4H6 + H2 |
| 214 | C6H5 + H + M = C6H6 + M |
| 215 | C2H2 + C4H4 = C6H6 |
| 216 | C4H5 + C2H2 = C6H6 + H |
| 217 | C2H3 + C4H5 = C6H6 + H2 |
| 218 | C3H3 + C3H3 = C6H6 |
| 219 | C2 + M = C + C + M |
| 220 | CH + M = C + H + M |
| 221 | C2H + M = C2 + H + M |
| 222 | CH2 + M = CH + H + M |
| 223 | C + H2 = CH + H |
| 224 | CH2 + M = C + H2 + M |
| 225 | C2H + H = C2 + H2 |
| | IV. Surface Reactions and soot formations |
| | Surface chemical reactions |
| 226 | C—H(S) + H => C(S) + H2 |
| 227 | C(S) + H => C—H(S) |
| 228 | C(S) + C2H2 => C—H(S) + C(B) + H |
| 229 | CH4 (+C—H(s)) => CH3 + H (+C—H(S)) |
| 230 | C2H4 (+C—H(S)) => C2H2 + H2 (+C—H(S)) |
| 231 | C2H6 (+C—H(S)) => CH3 + CH3 (+C—H(S)) |
| 232 | C3H4(+C—H(S)) => C2H2 + CH2 (+C—H(S)) |
| 233 | C(S) + C2H6 => C—H(S) + C2H5 |
| 233 | C + C—H(S) => C(B) + C—H(S) |
| 234 | C2 + C(S) => C(B) + C(S) |
| | Ion Molecule recombination in the wall |
| 235 | CH₅⁺ + E + W => CH₅ + W |
| 236 | CH₄⁺ + E + W => CH₄ + W |
| 237 | CH₃⁺ + E + W => CH₃ + W |
| 238 | CH₂⁺ + E + W => CH₂ + W |
| 239 | CH⁺ + E + W => CH + W |
| 240 | C⁺ + E + W => C + W |
| 241 | C₂H₅⁺ + E + W => C₂H₅ + W |
| 242 | C₂H₄⁺ + E + W => C₂H₄ + W |
| 243 | C₂H₃⁺ + E + W => C₂H₃ + W |
| 244 | C₂H₂⁺ + E + W => C₂H₂ + W |
| 245 | C₃Hₓ⁺ + E + W => C₃Hₓ + W |
| 246 | C₄Hₓ⁺ + E + W => C₄Hₓ + W |
| 247 | H2⁺ + E + W => H2 + W |
| 248 | H⁺ + E + W => H + W |
| 249 | CH₄* + W => CH₄ + W |
| 250 | CH* + W => CH + W |
| 251 | H* + W => H + W |

1-13. (canceled)

14. A method of operating a reactor including a reaction zone, comprising:
effecting a plasma discharge in the reaction zone;
contacting reactant matter with the plasma discharge such that a reactive process is effected to produce product matter including solid particulate matter; and
while the reactive process is being effected, flowing a particulate uncoupling gaseous fluid flow to mitigate coupling of the produced product matter to the reactor or to effect uncoupling of the produced product matter which becomes coupled to the reactor.

15. A method of operating a reactor including a reaction zone, comprising an operating cycle which is repeated at least once, such that at least two executions of the operating cycle are provided, wherein the operating cycle is defined by a first predetermined time interval and a second predetermined time interval, wherein the second predetermined time interval commences upon completion of the first predetermined time interval;
and wherein, during the first predetermined time interval, generation of a plasma discharge is effected by a plasma generator, and reactant matter is contacted with the plasma discharge such that a reactive process is effected to produce product matter including solid particulate matter which becomes physically coupled to at least a fraction of the plasma generator;
and wherein, during the second predetermined time interval, particulate uncoupling gaseous fluid is flowed and effects uncoupling of at least a fraction of the coupled solid particulate matter;
wherein substantially no particulate uncoupling gaseous fluid is flowed during the first predetermined time interval, and substantially no plasma discharge is effected during the second predetermined interval.

16. The method as claimed in claim 15, wherein the duration of the first predetermined time interval of at least one of the at least two executions of the operating cycle is not equal to the duration of the first predetermined time interval of another one of the at least two executions of the operating cycle, and wherein the duration of the second predetermined time interval of at least one of the at least two executions of the operating cycle is not equal to the duration of each one of at least another one of the at least two executions of the operating cycle.

17. The method as claimed in claim 15, wherein the plasma generator includes:
a current and voltage source;
a first electrode structure physically coupled to the reaction vessel, and including at least one operative surface electrically coupled to the current and voltage source for effecting an electrical discharge; and
a second electrode structure physically coupled to the reaction vessel, and including at least one operative surface configured for receiving the electrical discharge, wherein the second electrode structure is spaced apart from the first electrode structure and a reaction zone is defined between the first and second electrode structures;
wherein the plasma discharge is effected by the plasma generator from a plasma forming gaseous fluid disposed within the reaction zone while an electrical potential difference is applied between a one of the at least one operative surface of the first electrode structure and a respective one of the at least one operative surface of the second electrode structure by the current and voltage source so as to effect an electrical discharge between the one of the at least one operative surface of the first electrode structure and the respective one of the at least one operative surface of the second electrode structure and through the reaction zone.

18. The method as claimed in claim 17, wherein the coupled solid particulate matter is physically coupled to at least a fraction of the first electrode structure.

19. The method as claimed in claim 15, wherein for each one of the executions, the plasma discharge is substantially terminated prior to commencing the second predetermined time interval.

20. The method as claimed in claim 15 or 19, wherein, for each one of the executions, the flow of the particular uncoupling gaseous fluid is substantially terminated prior to commencing the first predetermined time interval.

21. The method as claimed in claim 20, wherein the duration of the first predetermined time interval is between 30 seconds and 120 seconds, and the duration of the second predetermined time interval is between 0.02 seconds and 0.1 seconds.

22. The method as claimed in claim 21,
wherein the particulate uncoupling gas is introduced through a particulate uncoupling gas inlet;
and wherein the pressure of the reaction zone during the first predetermined time interval is less than 20 psig;
and wherein the pressure gradient between the particulate uncoupling gas inlet and the reaction zone during the second predetermined time interval is greater than 100 psig.

23. The method as claimed in claim 15, wherein the duration of the first predetermined time interval is between 30 seconds and 120 seconds, and the duration of the second predetermined time interval is between 0.02 seconds and 0.1 seconds.

24. The method as claimed in claim 23,
wherein the particulate uncoupling gas is introduced through a particulate uncoupling gas inlet;
and wherein the pressure of the reaction zone during the first predetermined time interval is less than 20 psig;
and wherein the pressure gradient between the particulate uncoupling gas inlet and the reaction zone during the second predetermined time interval is greater than 100 psig.

25. Method of operating a reactor system including a plasma generator, comprising:
operating the reactor system in an experimental mode, including:
generating a test plasma discharge by the plasma generator;
contacting the test plasma discharge with test reactant matter, such that a reactive process is effected to produce test product matter including test solid particulate matter which becomes physically coupled to at least a fraction of the plasma generator; and
measuring the rate of physical coupling of the solid particulate matter; and
operating the reactor system in a normal operating mode, wherein the normal operating mode includes an operating cycle, wherein the operating cycle is defined by a first predetermined time interval and a second predetermined time interval, wherein the second predetermined time interval commences substantially after completion of the first predetermined time interval, and wherein the duration of the first predetermined time interval is based upon the measured rate of physical coupling of the solid particulate matter during the experimental mode;
and wherein, during the first predetermined time interval, generation of a normal operation plasma discharge is effected by the plasma generator, and normal operation reactant matter is contacted with the normal operation plasma discharge such that a reactive process is effected to produce normal operation product matter including normal operation solid particulate matter which become physically coupled to at least a fraction of the plasma generator;
and wherein, during the second time interval, particulate uncoupling gaseous fluid is flowed and effects uncoupling of at least a fraction of the coupled solid particulate matter;
and wherein substantially no particulate uncoupling gaseous fluid is flowed during the first predetermined time interval, and substantially no plasma discharge is effected during the second predetermined time interval.

26. The method as claimed in claim 25, wherein the operating cycle is repeated at least once such that at least two executions of the operating cycle are provided, and wherein the duration of the first predetermined time interval of each one of the executions is based upon the measure rate of physical coupling of the solid particulate matter during the experimental mode.

27-31. (canceled)
